(19) United States
(12) Patent Application Publication
(10) Pub. No.: US 2023/0077863 A1
(43) Pub. Date: Mar. 16, 2023

(54) SEARCH ALGORITHMS AND SAFETY VERIFICATION FOR COMPLIANT DOMAIN VOLUMES

(71) Applicant: Motional AD LLC, Boston, MA (US)

(72) Inventors: Scott D. Pendleton, Singapore (SG); Aleksandar Petrov Petrov, Boston, MA (US); Carter Tung Yung Fang, Boston, MA (US); Minh Khang Pham, Boston, MA (US); James Guo Ming Fu, Singapore (SG); You Hong Eng, Singapore (SG)

(21) Appl. No.: 17/941,712

(22) Filed: Sep. 9, 2022

Related U.S. Application Data
(60) Provisional application No. 63/242,488, filed on Sep. 9, 2021.
(60) Provisional application No. 63/403,606, filed on Sep. 2, 2022.

(51) Int. Cl. B60W 60/00; B60W 50/00; G08G 1/16

(52) U.S. Cl. CPC B60W 60/0015; B60W 50/0098; G08G 1/16

(57) ABSTRACT

Provided are methods for search algorithms and safety verification for compliant domain volumes. The present techniques include identifying a parameterized scenario space and objective function. A boundary between compliant scenarios and non-compliant scenarios for metrics in the parameterized scenario space is determined. A total boundary of a domain volume corresponding to the parameterized scenario space is identified based on the boundaries between the compliant scenarios and non-compliant scenarios for each metric in the parameterized scenario space.

### CROSS-REFERENCE TO RELATED APPLICATIONS

This application claims priority to U.S. Provisional Application No. 63/403,606 filed on Sep. 2, 2022 and U.S. Provisional Application No. 63/242,488 filed on Sep. 9, 2021, the entire contents of each are incorporated herein by reference.

### BACKGROUND

Autonomous systems are designed with an emphasis on safety. Generally, safety is associated with low levels of risk. For example, safety can refer to the ability to operate the autonomous system with a sufficiently low level of risk. Safety can also refer to functional safety in which the system functions with a sufficiently low level of risk.

### BRIEF DESCRIPTION OF THE FIGURES

FIG. 1 is an example environment in which a vehicle including one or more components of an autonomous system can be implemented.

FIG. 2 is a diagram of one or more systems of a vehicle including an autonomous system.

FIG. 3 is a diagram of components of one or more devices and/or one or more systems of FIGS. 1 and 2.

FIG. 4A is a diagram of components of an autonomous system.

FIG. 4B is a block diagram of an implementation of active learning system that identifies compliant domain volumes.

FIG. 5 is a diagram of an implementation of a search algorithm and safety verification for compliant domain volumes.

FIG. 6 is an illustration of scenarios.

FIG. 7 is a block diagram of a system for execution of search algorithms and safety verification for compliant domain volumes.

FIG. 8 is another illustration of parametrized scenarios.

FIG. 9 is an illustration of the exploration of multiple surfaces simultaneously.

FIG. 10 is an illustration of quality of the boundary estimates vs number of samples.

FIG. 11 shows a ground truth surface.

FIG. 12 shows a jaywalker scenario and an unprotected turn scenario.

FIGS. 13A and 13B show truth values for the three metrics.

FIG. 14 is a comparison of algorithms for a single continuous metric.

FIG. 15 shows a comparison of single binary metric algorithms.

FIG. 16 shows selected sampling locations for the multiple metrics case with the ground truth compliance boundaries plotted for the three metrics.

FIG. 17 is an illustration of a compliance boundary in an example scenario.

FIG. 18 is an illustration of points on the no traffic conflict compliance boundary for the unprotected turn scenario before and after.

FIG. 19 is an illustration of a plot of the tracks of the AV and agent for the two marked cases in FIG. 18.

FIG. 20 is a process flow diagram of a method for search algorithms and safety verification using compliant domain volumes.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

General Overview

In some aspects and/or embodiments, systems, methods, and computer program products described herein include and/or implement search algorithms and safety verification for compliant domain volumes. The present techniques include receiving a parameterized scenario space and at least one objective function. A boundary between compliant and non-compliant subspaces for each metric in the parameterized scenario space is determined. A compliant domain volume boundary for the parameterized scenario space is identified based on the boundaries between the compliant and non-compliant (metric) values for each metric in the parameterized scenario space. Determining the boundary between compliant and non-compliant subspace for each metric is based on, at least in part, a data type associated with each metric. For example, a data type is a single rule with a continuous metric, a single rule with a binary metric, collection of rules, combination of rules, hierarchy of rules, or any combinations thereof.

Generally, the present techniques are applicable to any autonomous system, including but not limited to autonomous vehicles. For example, the present techniques can be applied to manufacturing automation (e.g., robot arm manipulation), humanoid robot operation, or smart infrastructure management. In examples, the present techniques apply to any system with actuators (e.g., component that achieves physical movements via energy conversion to execute planned actions) and sensors (e.g., components that detect or measures a physical property (e.g., of an object, group of objects, and/or environment and records, indicates, or otherwise responds to the physical property, sensors measure metrics evaluating compliance of actions executed by at least on actuator).

A determination of safety is made by simulating scenarios and observing the autonomous system's response to the simulated scenario. A technical advantage of the present techniques is quickly catching potential safety issues and with fewer costs and resources when compared to traditional techniques. Another technical advantage is automatically identification of edge-case scenarios with as few simulation runs as possible. In embodiments, the present techniques enable an automatic search for adversarial scenarios.

By virtue of the implementation of systems, methods, and computer program products described herein, techniques for search algorithms and safety verification for compliant domain volumes enables exploration of the compliance boundary for binary and continuous metrics, either alone or in any combination. The number of simulations needed to fully explore AV behavior is reduced when compared to traditional techniques, such as a parameter sweep. Additionally, the present techniques are applicable to high-dimension parameterized spaces.

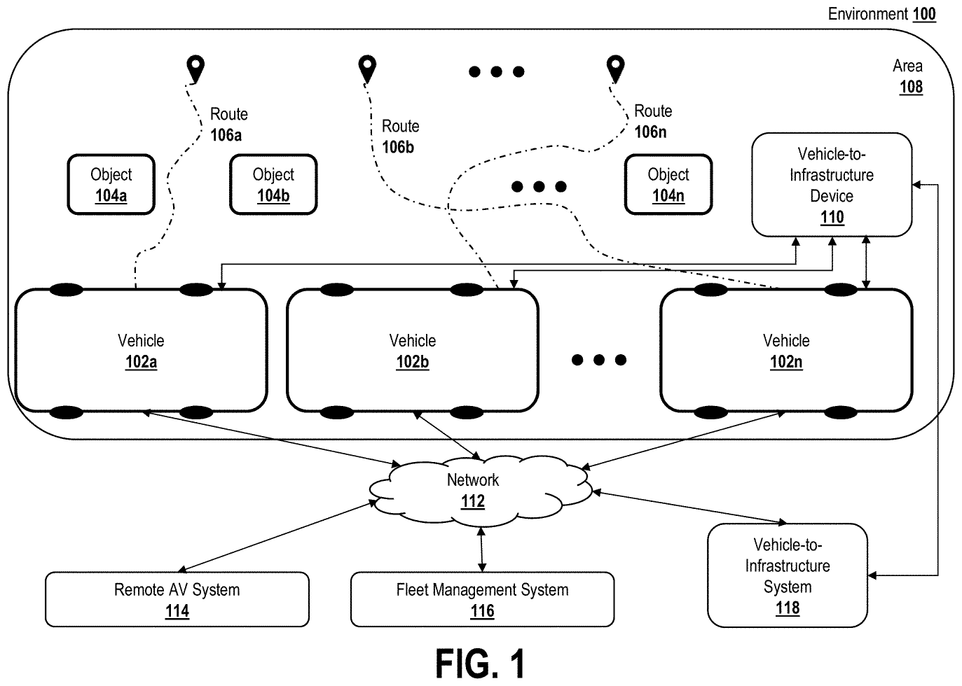

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

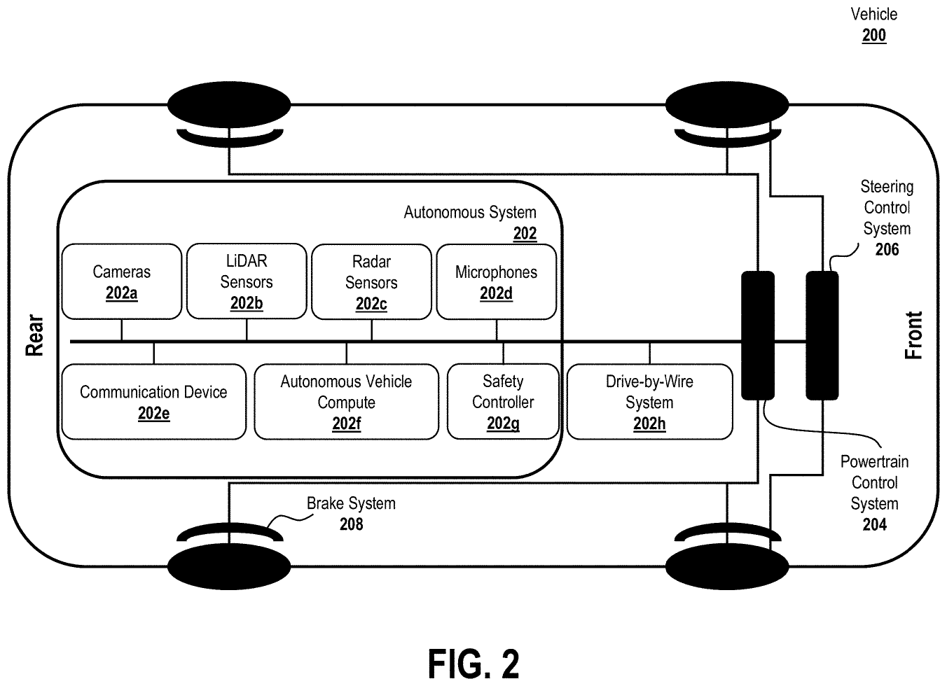

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited look ahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, remote AV system 114, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 includes autonomous system 202, powertrain control system 204, steering control system 206, and brake system 208. In some embodiments, vehicle 200 is the same as or similar to vehicle 102 (see FIG. 1). In some embodiments, vehicle 102 have autonomous capability (e.g., implement at least one function, feature, device, and/or the like that enable vehicle 200 to be partially or fully operated without human intervention including, without limitation, fully autonomous vehicles (e.g., vehicles that forego reliance on human intervention), highly autonomous vehicles (e.g., vehicles that forego reliance on human intervention in certain situations), and/or the like). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, and drive-by-wire (DBW) system 202h.

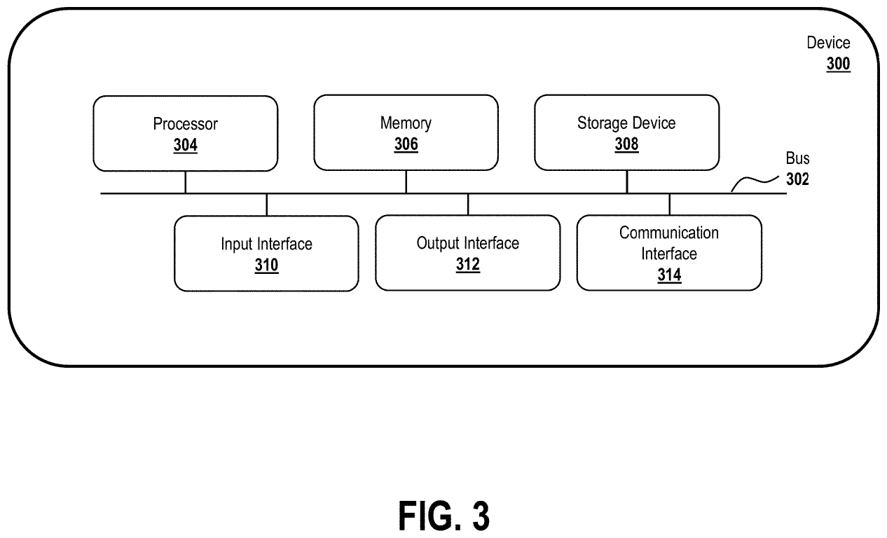

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a charge-coupled device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Laser Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum. In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e include at least one device configured to be in communication with cameras 202a, LiDAR sensors 202b, radar sensors 202c, microphones 202d, autonomous vehicle compute 202f, safety controller 202g, and/or DBW system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like) a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to start moving forward, stop moving forward, start moving backward, stop moving backward, accelerate in a direction, decelerate in a direction, perform a left turn, perform a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), and/or one or more devices of network 112 (e.g., one or more devices of a system of network 112). In some embodiments, one or more devices of vehicles 102 (e.g., one or more devices of a system of vehicles 102), and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some embodiments, processor 304 is implemented in hardware, software, or a combination of hardware and software. In some examples, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a WiFi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

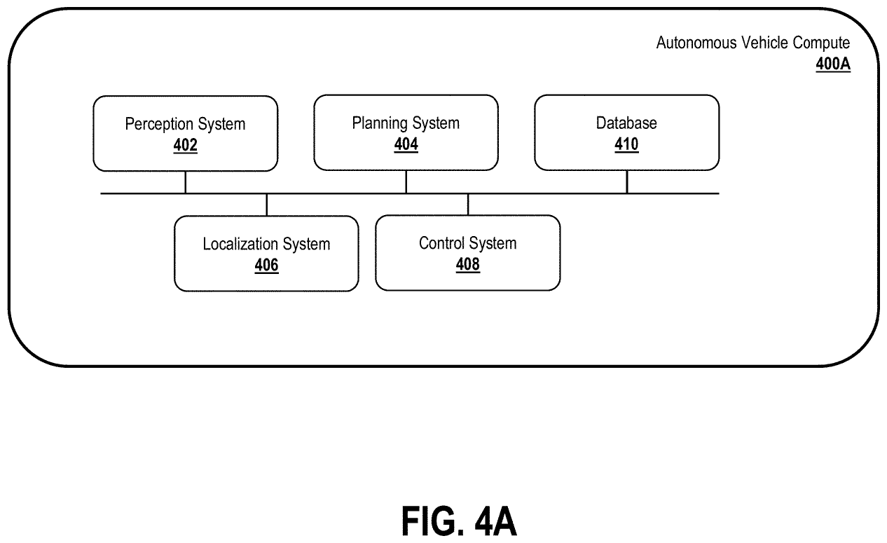

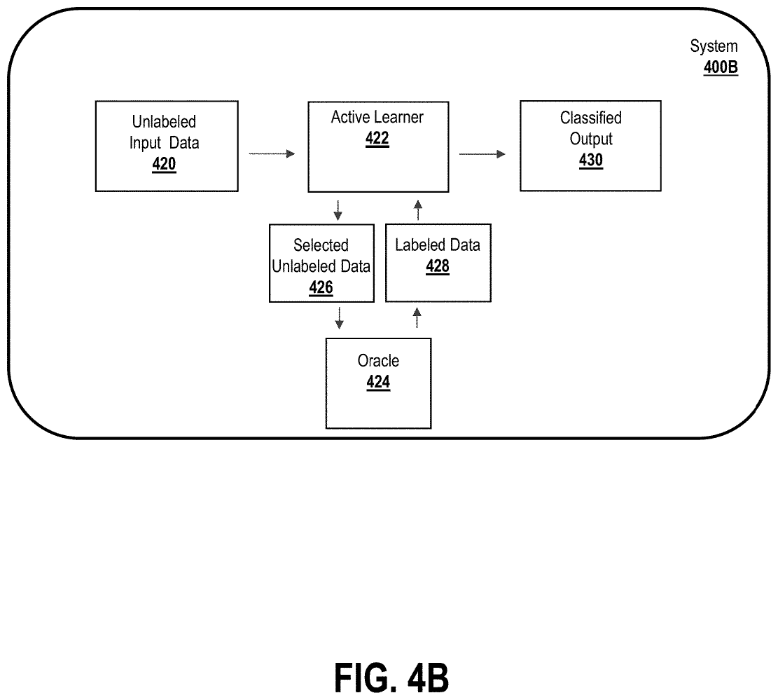

Referring now to FIG. 4A, illustrated is an example block diagram of an autonomous vehicle compute 400A (sometimes referred to as an “AV stack”). As illustrated, autonomous vehicle compute 400A includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400A and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400A are implemented in software (e.g., in software instructions stored in memory), computer hardware (e.g., by microprocessors, microcontrollers, application-specific integrated circuits [ASICs], Field Programmable Gate Arrays (FPGAs), and/or the like), or combinations of computer software and computer hardware. It will also be understood that, in some embodiments, autonomous vehicle compute 400A is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like). An example of an implementation of a machine learning model is included below with respect to FIGS. 4B-4D.

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

FIG. 4B is a block diagram of an implementation of an active learning (AL) system 400B to identify compliant search volumes. More specifically, illustrated is a diagram of active learning (e.g., an implementation of machine learning), wherein a machine learning model interactively generates queries to output labels assigned to unlabeled data points. For purposes of illustration, the following description of AL system 400B will be with respect to an implementation of active learning by planning system 404. However, it will be understood that in some examples AL model 400B 420 (e.g., one or more components of AL system 400B) is implemented by other systems different from, or in addition to, planning system 404, such as perception system 402, localization system 406, and/or control system 408. While the AL system 400B includes certain features as described herein, these features are provided for the purpose of illustration and are not intended to limit the present disclosure.

The active learning system 400B obtains unlabeled input data 420. An active learner 422 queries an oracle 424 to label at least a portion of the unlabeled input data 420. In some embodiments, the active learner is iteratively updated based on the output of other active learners applied to a same domain volume. In examples, the unlabeled input data 420 is, for example, from data generated by autonomous system 202 of FIG. 2, device 300 of FIG. 3, autonomous vehicle compute 400A (e.g., perception system 402, planning system 404, localization system 406, control system 408, database 410) of FIG. 4A, or any combinations thereof. In examples, the data is associated with an autonomous system. In some embodiments, the active learner 422 is an algorithm or machine learning model that determines labels corresponding to the unlabeled input data through iterative supervised learning. The active learner 422 selects from the unlabeled input data 420 to determine the data used to query the oracle 424. In some embodiments, the active learner 422 is based on, at least in part, Support Vector Machines (SVMs), Gaussian Processes (GPs), or Reinforcement Learning (RL). In some embodiments, the active learner is based on other algorithms as described herein.

In some embodiments, the oracle 424 cleans, selects, and labels selected unlabeled input data 426 as selected by the active learner 422. For example, the oracle 424 generates estimates for the labels of all samples from the portion of the selected unlabeled input data 426. The oracle returns labeled data 428 to the active learner 426. The labeled data 426 includes estimates for the labels of all samples corresponding to the selected unlabeled input data 426. The active learner 422 outputs classified output 430. Through active learning, the present techniques determine interesting data points and request labels for the interesting data points. In some embodiments, the active learning system 400B reduces the long cycle lag time from feature introduction to identification of limitations/bugs in autonomous systems. Active learning according to the present techniques enables identification of both compliant domain boundaries and critical test case sets given an input parameterized scenario space and at least one objective function.

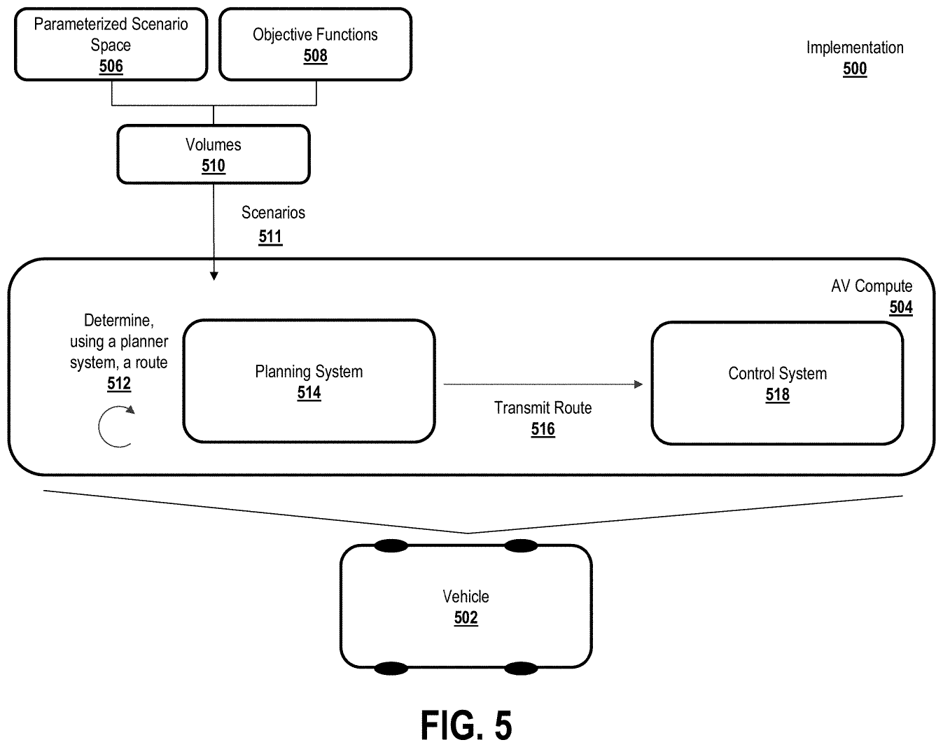

Referring now to FIG. 5, illustrated is a diagram of an implementation 500 of a search algorithm and safety verification for compliant domain volumes. In some embodiments, one or more of the components or devices described with respect to the implementation 500 are implemented (e.g., completely, partially, and/or the like) by autonomous vehicle 102 of FIG. 1, the autonomous system 202 of FIG. 2, the device 300 of FIG. 3, the autonomous vehicle compute 400A of FIG. 4A, and/or the active learning system 400B of FIG. 4B.

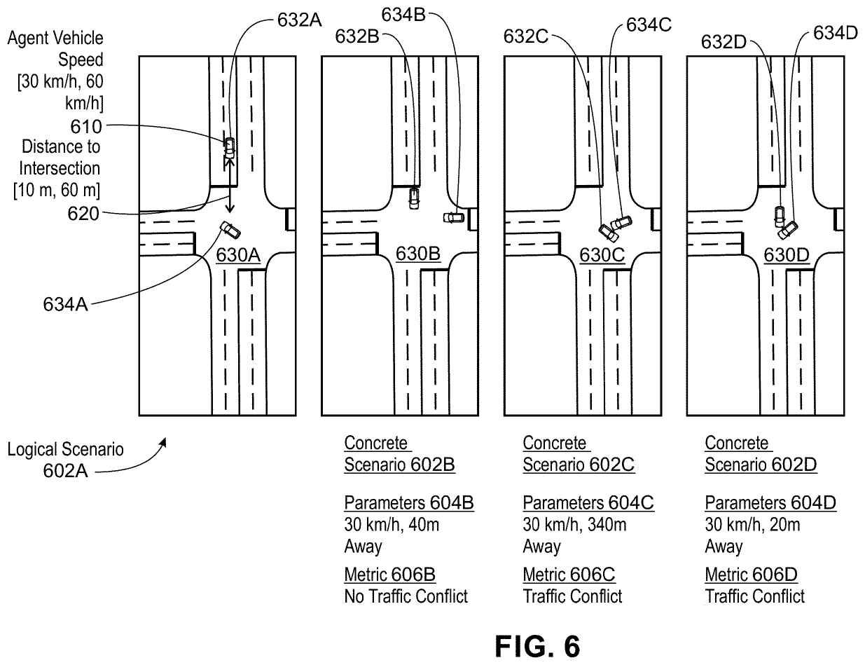

In examples, an autonomous system (e.g., autonomous vehicle 502) is tested within an operational design domain (ODD). Generally, the ODD refers to operating conditions under which a given autonomous system or autonomous system feature is specifically designed to function. In the example of an AV, the ODD includes, but not limited to, environmental, geographical, and time-of-day restrictions, and/or the requisite presence or absence of certain traffic or roadway characteristics. The behavior of the AV is the response of the AV to the operating conditions it encounters, based on its performance or technology limitations. During a simulation, the operating conditions are parameterized, or defined by one or more parameters. Vehicle functions can also be parameterized. For example, tire performance can be a parameter that affects the AV behavior during a simulation. In another example, LiDAR performance is a parameter that affects the AV behavior during a simulation. The present techniques enable parameterization of environment agent behaviors (e.g., parameters 604B-60D of FIG. 6).

In some embodiments, operation of the vehicle 502 is simulated by providing sensor data representative of scenarios as input to an AV compute 504 (e.g., AV stack. For example, sensor data representative of scenarios from a parameterized scenario space 506 are provided as input to planning system 514, which is the same as or similar to planning system 404 of FIG. 4A as included and/or implemented in an autonomous navigation system of a vehicle (e.g., autonomous vehicle compute 202f of vehicle 200). In some embodiments, the parameterized scenario space 506 is selected to cover the ODD. The planning system 514 determines a route (512) and transmits a route (516) to a control system 518. The control system 518 is the same as or similar to control system 408 of FIG. 4A as included and/or implemented in an autonomous navigation system of a vehicle (e.g., autonomous vehicle compute 202f of vehicle 200).

In some embodiments, the parameterized scenario space 506 includes multiple parameterized/logical scenarios (referred to as logical scenarios), where a respective logical scenario includes at least one parameter of the parameterized scenario space. Parameters are variables that define aspects of a respective logical scenario. In examples, the logical scenario is a sequence or development of traffic events. Parameters include, for example, one or more actors, one or more agents (e.g., other vehicles pedestrians or cyclists), a location, velocity, or other information that describes the environment and the actors or agents in the environment. Accordingly, in some embodiments, the actors or agents in the environment function during simulation according to at least one parameter. In examples, the parameterized scenario space 506 includes parameters that approximate or largely correspond to an ODD.

Each point in the parameterized scenario space 506 is a set of concrete values assigned to parameters of the parameterized scenario space, creating a concrete scenario. In examples, a concrete scenario is a scenario where there is no unspecified parameter value. In examples, a respective logical scenario corresponds to multiple concrete scenarios with varying parameter values. Generally, logical scenarios are prototypes or schemas of scenarios which become concrete scenarios when concrete values for parameters of the scenario are provided. In examples, the concrete scenarios include parameters that approximate or largely correspond to a test case within an ODD. Simulation results are obtained by identifying concrete scenarios to evaluate objective functions 508. The objective functions represents a goal or desired output of the autonomous system. The objective function defines criteria for evaluating logical scenarios. In some embodiments, compliant and non-compliant values are identified for each objective function, and a boundary for each metric is based on, at least in part, a data type of the objective function. In some embodiments, evaluating concrete scenarios extracted from the parameterized scenario space 506 according to the objective functions 508 results in boundaries that delineate compliant and non-compliant scenarios for each objective function. The compliant and non-compliant scenarios of the parameterized scenario space 506 associated with the objective functions 508 are used to form compliant and non-compliant domain volumes 510. In some embodiments, concrete scenarios 511 at or near the boundaries of the compliant and non-compliant domain volumes 510 are simulated at the vehicle 502. The concrete scenarios 511 used for simulation represent edge case scenarios, and provide more meaningful and informative data (e.g., the response of the autonomous system) when used for simulation when compared to concrete scenarios that are deep-seated within compliant or non-compliant regions of the parameterized scenario space.

In some embodiments, the objective functions 508 are metrics that evaluate the response of an autonomous system in a concrete scenario. In an example where the autonomous system is an AV, example metrics include evaluating if the AV obeyed the traffic rules, if the AV and other road actors were involved in a traffic conflict, did the AV drive smoothly, and so on. In examples, parameters of concrete scenarios extracted from the parameterized scenario space govern the simulation environment, while the metrics evaluate how the autonomous system software stack performs in the simulation environment. In the example where the autonomous system is an AV, evaluating concrete scenarios extracted from the parameterized scenario space 506 according to the metrics results in boundaries that delineate compliant and non-compliant scenarios in view of the metrics.

For ease of description, the present techniques are generally described with reference to implementation by a planning system (e.g., planning system 404 of FIG. 4A) of an AV. However, the present techniques are applicable to any simulation. The present techniques are generally applicable to simulations where the real word physical implementation of the simulation is at a great cost. In examples, the present techniques extend to physical simulations (e.g., scale model testing), where the simulations are executed in some manner by which the cost is reduced relative to real deployment. Additionally, other autonomous systems such as robots are used according to the present techniques. In examples, the present techniques are used to simulate medical procedures, food manufacturing, or other process industry applications. When physical testing is performed, the present techniques reduce the number of scenarios executed on a physical system, which can be extremely costly.

Compliant domain volumes are identified to verify that desired design objectives are met. In some embodiments, the compliant and non-compliant domain volumes are used to build a safety case or for prioritizing ongoing development targets of an autonomous system. For example, some changes in compliant domain volumes indicate regression of the autonomous system or improvement of the autonomous system. Further, some changes in compliant domain volumes indicate a lack of regression in the autonomous system or improvement in the autonomous system, where the domain improves in some parts and regresses in others to create an a non-trivially comparable state. The present techniques evaluate these states using the identified compliant and non-compliant scenarios of the domain volume.

In some embodiments, exploration (e.g., search) algorithms used to extract the identified compliant domain volumes incorporate, for example, parallelization through asynchronous selection of sampling points. In examples, asynchronous selection of sampling points is done through a batch sampling algorithm. The exploration algorithms are selected based on, at least in part, on the type of objective functions used to evaluate a respective scenario of the parameterized scenario space. In examples, the objective functions are metrics that include, continuous and binary metrics, hierarchical metrics, categorical metrics, metrics with structured output, and any combinations thereof. The algorithms include, but are not limited to, a genetic algorithms (GA), support vector machine (SVM), Gaussian Process (GP), or any combinations thereof.

FIG. 6 is an illustration of concrete scenarios corresponding to a logical scenario 602A. The concrete scenarios 602B, 602C, and 602D are concrete implementations of the logical scenario 602A. The concrete scenarios 602B, 602C, and 602D are data points within a parameterized scenario space (e.g., parameterized scenario space 506 of FIG. 5). The logical scenario 602A includes parameters that represent an environment as an AV navigates on approach to an intersection 630A-630D. For ease of description, the parameters identified in the logical scenario are a speed (610) of an agent and a distance of the agent to intersection (620). However, any number of parameters can be identified in the logical scenario, including but not limited to speed of agents, direction/heading of agents, objects in the environment, road conditions, environmental conditions, traffic conditions, AV control variables, and the like. In examples, AV control variables govern an aspect of AV behavior during the simulation. For example, an AV control variable (e.g., parameter) is the AV velocity at time of agent first appearance. In examples, velocity is an AV control variable, and the AV executes different speed profiles in response to the varied parameterizations of the scenario. The parameters, scenarios, and rules described herein are for descriptive purposes, and do not necessarily correspond to actual performance of software or vehicles.

In the example of FIG. 6, different parameterizations of the logical scenario 602A result in varying agent 632A behavior and subsequently differing AV 634A behavior in response. For purposes of description, the metric used to evaluate the AV in FIG. 6 is the presence or absence of traffic conflicts, however any metric can be used. In examples, a traffic conflicts is contact between the AV and an actor in the simulated environment. In examples, a near traffic conflict is a traffic event in which no property was damaged and no personal injury was sustained, but where, given the absence of an evasive maneuver, damage or injury easily could have occurred. A near traffic conflict is an occurrence defined by a possibility of a traffic conflict but for a maneuver initiated by the vehicle. In some examples, the present techniques are described using rules of the road generally applicable to left-hand traffic (e.g., locations that drive on the left side of the road). However, the present techniques also apply to right-hand traffic.

The logical scenario 602A includes an agent vehicle speed (610) within a range from 30 km/h to 60 km/h. Agent distance to the intersection (620) is from 10 m to 60 m. The AV 634A is assigned a route that includes a turn at the intersection 630A that crosses the agent 632 vehicle's path. Each concrete scenario 602B, 602C, and 602D is a collection of parameters 604B, 604C, and 604D to which rules are applied. As illustrated in the example of FIG. 6, the parameters 604B, 604C, and 604D vary for each respective concrete scenario 602B. Based on the rules applied to the respective parameters of each concrete scenarios, metrics 606B, 606C, and 606D are observed during a simulation corresponding to the parameters. In some examples, parameters define scenarios while metrics are a standard, value, rule, or other observation that occurs during a simulation of a respective scenario.

In the example of FIG. 6, a concrete scenario 602B includes an agent 632B and AV 634B. Parameters 604B of the concrete scenario 602B include an agent vehicle speed of 30 km/h, with the agent vehicle approaching the intersection 630B from a distance of 40 m. In concrete scenario 602B, metric 606B indicates no traffic conflict occurs as the AV 634B clears the intersection prior to the agent 634B vehicle crossing the intersection 630B. Thus, concrete scenario 602B is free of traffic conflicts.

Concrete scenario 602C includes an agent 632C and AV 634C. Parameters 604C of the concrete scenario 602C include an agent vehicle speed of 30 km/h, with the agent vehicle approaching the intersection 630C from a distance of 30 m. In concrete scenario 602C, metric 606C indicates a traffic conflict occurs as the AV 634C does not clear the intersection 630C prior to the agent 632C vehicle entering the intersection 630C. Thus, concrete scenario 602C results in a traffic conflict between the AV 634C and the agent 634C vehicle. Similarly, concrete scenario 602D includes an agent 632D and an AV 634D. Parameters 604D of the concrete scenario 602D include an agent vehicle speed of 30 km/h, with the agent vehicle approaching the intersection 630D from a distance of 20 m. In concrete scenario 602D, metric 606D indicates a conflict occurs as the AV 634D does not clear the intersection prior to the agent 632D vehicle entering the intersection 630D. Thus, concrete scenario 602D results in a traffic conflict between the AV 634D and the agent 634D vehicle. As shown in FIG. 6, the agent vehicle moves with the same velocity (e.g., 30 km/hr) in each of the concrete scenarios 602B-602D. However, the speed of the agent vehicle and actors within the environment can vary as the agents and actors move throughout the environment.

In the example of FIG. 6, the AV turns across a lane of traffic in which the agent vehicle is traveling while the agent vehicle has the right of way. In the example of FIG. 6, a goal for the AV is to not crash into the agent vehicle as the AV turns across the agent vehicle's path. To create a parameterized scenario, conditions in the logical scenario are specified. Parameters associated with various conditions are changed to create an array of concrete scenarios 602B-602D. As illustrated in the example of FIG. 6, the distance of the agent vehicle to the intersection is changed across the concrete scenarios.

The present techniques enable a determination of the precise boundary in the parameterized scenario space (logical scenario space) where the autonomous system behavior transitions from compliant to non-compliant. Some techniques are limited to simulation of a set of concrete scenarios. With some techniques, each time a change is made (e.g., a change to the autonomous system's decision making algorithms), all concrete scenarios are re-tested via simulation. With some techniques, the set is fixed (e.g., static). The ODD of an autonomous system is much broader than a set of fixed scenarios and cannot be covered by a finite set of fixed scenarios. As a result, the use of fixed scenarios as a set of test cases potentially misses or over-emphasizes many issues with small variations in the scenarios. Parameterization of the scenarios enables the discovery of scenarios in which the autonomous system performs poorly, however the number scenarios executed via simulation potentially grows to an infeasible number when executing all scenarios. For example, in a logical scenario with two parameters and forty sample points for each parameter, 1600 scenarios can be derived, resulting in 1600 simulations for a single logical scenario. In another example, when five parameters are used, the number of simulations increases to 40⁵ simulations. When the number of parameters per scenario grows, the number of simulations used to evaluate the scenario grows exponentially. The higher the number of metrics used to evaluate a scenario, the larger the number of test cases available within the ODD. In the example of five parameters with 40 levels each, at least one million cases are available within the ODD. Simulating the at least one million cases consumes approximately twelve days of time at one second per simulation. A technical advantage of the present techniques is the efficient exploration of the parameterized scenario space without a need to execute simulations for all possible scenarios available within the parameterized scenario space.

To enable efficient exploration of the scenario space, the present techniques determine a boundary between the safe behavior (e.g., a compliant scenario parameter volume) and the unsafe behavior (e.g., an uncompliant scenario parameter volume) in view of at least one metric. Active learning is used to identify the boundary, where the boundary is associated with concrete scenarios along the actual boundary. The exploration process produces examples of compliant and non-compliant behavior for concrete scenarios adjacent to the boundary. Simulating test cases along the boundary between compliant and non-compliant behavior enables the execution of fewer simulations to pinpoint a failure that causes noncompliant (unsafe) behavior of the AV. This results in fewer simulations with the same insight as running a large number of simulations.

Scenarios at or near the boundary between safe and unsafe behavior provide more meaningful and informative data when compared to scenarios that are clearly safe or unsafe. Thus, the boundary between safe and unsafe behavior often includes edge case scenarios. In the example of FIG. 6, the series of concrete scenarios 602B-602D are located in a parameterized scenario space near a boundary between safe and unsafe behavior. In each scenario, the agent vehicle approaches an intersection as the AV makes a turn to cross the agent vehicle's path. However, in the concrete scenario 602B, the agent vehicle clears the intersection and the AV does not cause a traffic conflict with the agent vehicle. In concrete scenario 602C and concrete scenario 602D, a traffic conflict occurs between the AV and the agent vehicle. In embodiments, the present techniques are able to determine these edge case scenarios via active learning.

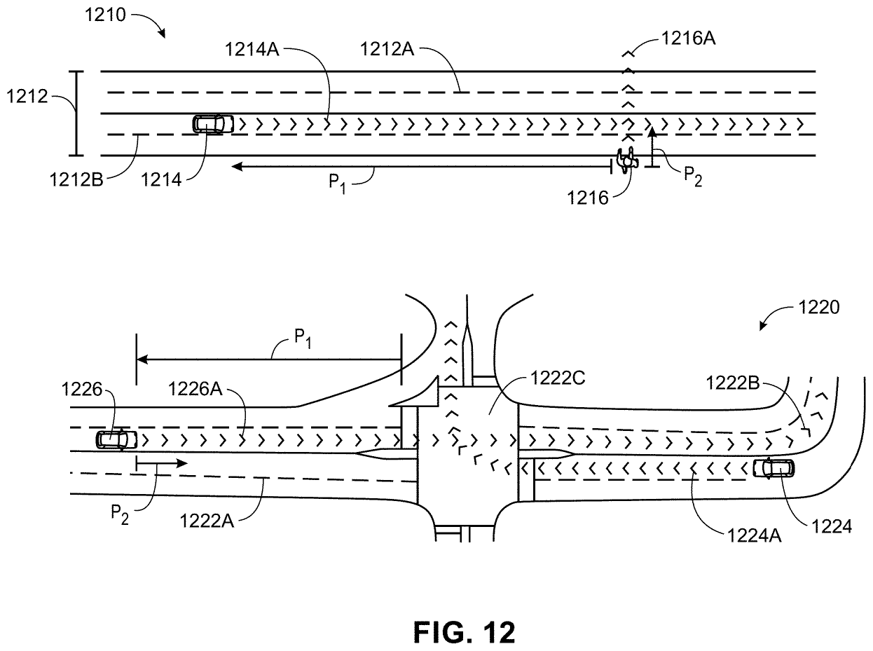

In examples, the edge case scenarios are those where the AV minimally satisfies ODD requirements for safe operation (e.g., the AV barely avoids a traffic conflict, a near traffic conflict) or the AV minimally fails the ODD requirements for safe operation (e.g., the AV is minimally involved in a traffic conflict). These scenarios are the most informative of the boundaries between safe and unsafe behavior. Accordingly, these scenarios more accurately identify informative vehicle behaviors. The edge case scenarios (e.g., test cases) are generally referred to as boundary test cases identified by a framework that explores the parameterized scenario space (e.g., the framework discussed AV example in FIGS. 12-19). In some embodiments, the boundary test cases are the scenarios (e.g., test cases) that can be focused on to improve the AV stack. In some embodiments, the boundary test cases are the test cases that slightly fail or slightly pass with respect to a parameterized scenario. Put another way, the boundary test cases are those test cases that an AV barely misses or barely satisfies requirements. By extracting and analyzing these test cases, a determination can be made about the particular component of the AV stack that is the root cause of failure.

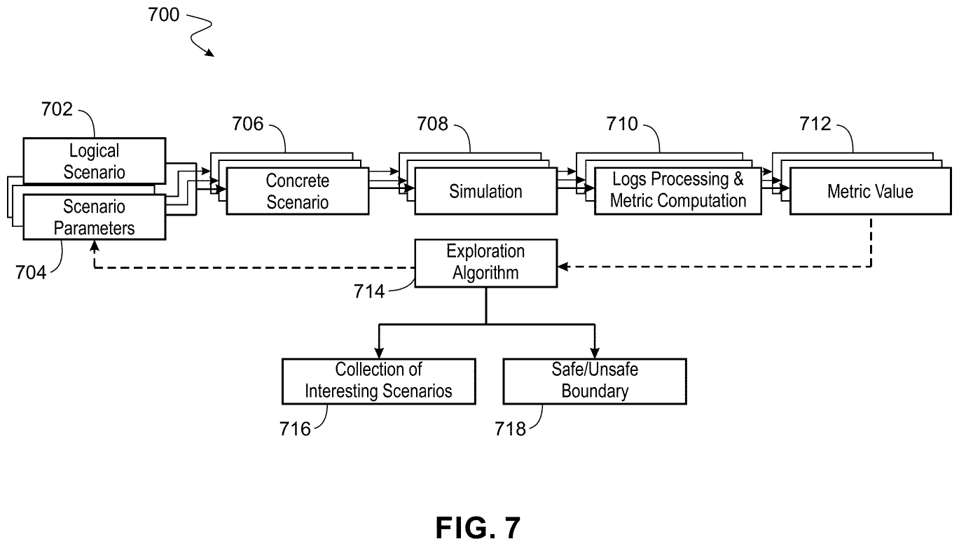

FIG. 7 is a block diagram of a system for execution of search algorithms and safety verification for compliant domain volumes. In some embodiments, system 700 is implemented (e.g., completely, partially, etc.) using a remote autonomous vehicle (AV) system 114, fleet management system 116, or V2I system 118 of FIG. 1. In some embodiments, one or more of the steps described as executed by the system 700 are performed (e.g., completely, partially, and/or the like) a planning system (e.g., planning system 404 of FIG. 4A), by another device or system, or another group of devices and/or systems that are separate from, or include, the planning system. In some embodiments, the steps described as executed by the system 700 may be performed between any of the above-noted systems in cooperation with one another.

In the example of FIG. 7, a logical scenario 702 and parameters 704 are used to create concrete scenarios 706. The concrete scenarios 706 are simulated by the autonomous system. After the simulations 708, logs processing and metric computation 710 are performed for each simulation. In examples, the output of the simulation at the autonomous system are data logs and other values used to determine at least one metric. Metric values 712 are determined and provided to an exploration algorithm 714. In examples, the exploration algorithm 714 corresponds to at least one exploration procedure to identify boundaries within the parameterized scenario space (e.g., parameterized scenario space 506 of FIG. 5). The exploration algorithm 714 selects the next scenario parameters to simulate at the autonomous system. The exploration algorithm 714 outputs a collection of interesting scenarios (716) and a boundary (718) corresponding to a response surface for each metric. In examples, the exploration algorithm refers to an active learning system (e.g., active learning system 400B of FIG. 4B) that identifies scenarios corresponding to the boundary between compliant and non-compliant behavior. Exploration parameters are used to determine a collection of interesting scenarios and the safe/unsafe boundary. Exploration parameters are based on, at least in part, exploration algorithm and control the exploration process. Examples of exploration parameters include a genetic algorithm having probabilities of crossover and mutation, population size, number of generations. In examples, Support Vector Machine (SVM) parameters include kernel type, tolerance for stopping criterion, maximum iteration, class weight, and the like. Exemplary algorithms include, but are not limited to genetic algorithms, SVMs, and Gaussian algorithms. In examples, genetic algorithms (GA) include using surrogate cost functions (e.g. missed distance). In examples, SVMs are applied directly on the binary traffic conflict/no traffic conflict metric. The listed algorithms are exemplary and should not be considered exhaustive. Exploration algorithms are further described with respect to FIGS. 12-19.

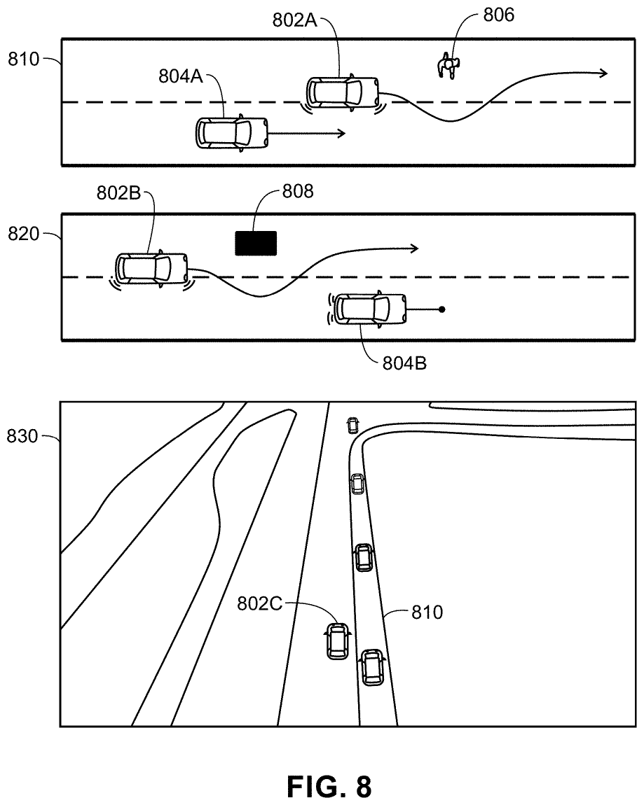

FIG. 8 is an illustration of parametrized scenarios. The example of FIG. 8 includes a jaywalker scenario (above), a blocked oncoming scenario (middle), and a lane change scenario (below). For purposes of description, the present techniques are described using the examples of a jaywalker, blocked path, and a lane change. However, the present techniques can be used in other scenarios. Additionally, the metrics described in each scenario are examples, and other or additional metrics can be implemented according to the present techniques.

In the jaywalker scenario 810, the AV 802A and vehicle 804A are traveling in respective lanes. A jaywalker 806 enters the lane in which the AV 802A is traveling. The AV 802A crosses a lane marker, entering the lane of the vehicle 804A. In this example, metrics include a jaywalker longitudinal distance, jaywalker lateral distance, and a jaywalker velocity. In some embodiments, the metrics are determined based on (e.g., relative to) a feature of the drivable surface area such as surface boundaries and/or vehicles operating on the drivable surface.

In a blocked oncoming scenario 820, the AV 802B and vehicle 804B are traveling in respective lanes. An object 808 blocks the lane in which the AV 802B is traveling. The AV 802B crosses a lane marker, entering the lane of the vehicle 804B. In this example, metrics include agent longitudinal distance to bus, agent lateral distance from bus, ego distance to bus, and agent velocity. In a lane change scenario 830, the AV 802C is traveling in a first lane and attempts to merge into a lane 810 with multiple other vehicles. In this example, metrics include an agent start delay, an agent offset from intersection, and an agent velocity.

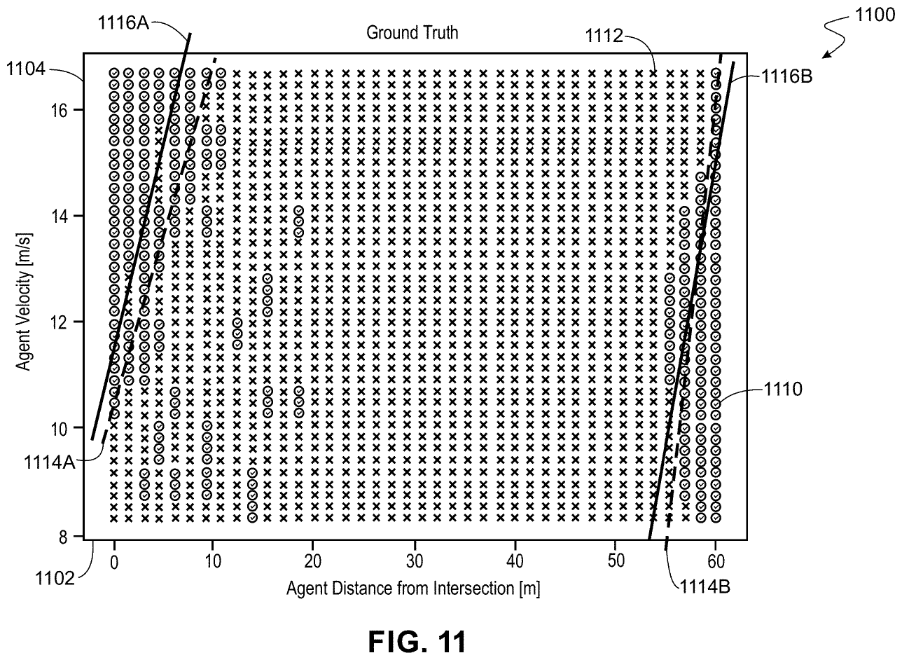

In some embodiments, active learning is implemented to estimate a response surface, where a response surface explores the relationship between multiple parameters and the resulting response of the AV based on observation of the metric. Each metric corresponds to a response surface that includes (e.g., is represented by) multiple data points, each data point representing varying combinations of the parameters. In examples, the data points are identified as compliant or non-compliant, creating a boundary between safe and un-safe scenarios. Using one or more surfaces, samples are actively selected from the parameterized scenario space while minimizing the number of samples for a given estimate quality level. Traditional techniques generally explore a space rather than refining the relevant boundaries (e.g. exploitation) within the space. In some embodiments, active learning measures the responsiveness of the objective functions (e.g., metrics). For examples, active learning enables measurement of the responsiveness of objective functions by choosing where to sample the parameterized scenario space. A minimum number of samples are selected for a preset quality level of scenarios, where the quality level is how far the sample is from a ground truth response surface (e.g., ground truth response surface 1100 of FIG. 11). The resulting boundary between safe and unsafe volumes is explored to evaluate the behavior of the autonomous system. In embodiments, the present techniques discard scenarios that are extremely safe or extremely dangerous.

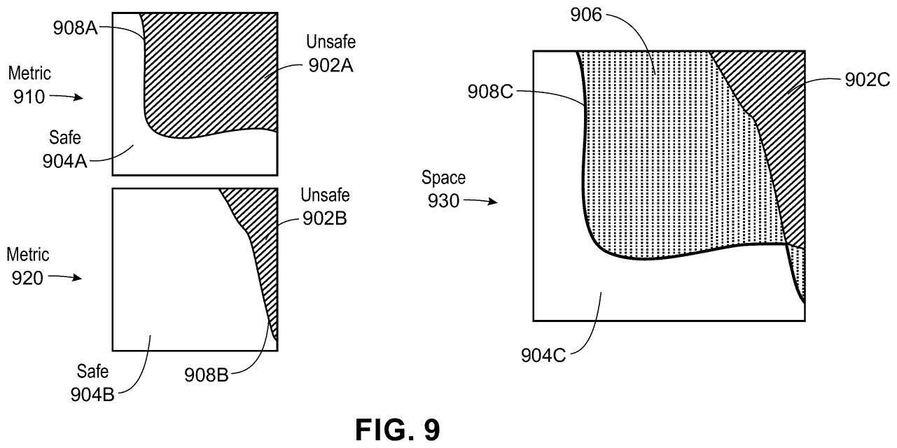

FIG. 9 is an illustration of the exploration of multiple surfaces simultaneously. In the example of FIG. 9, the surface 910 represents a first metric where the response of an AV to concrete scenarios is identified as compliant/safe 904A or non-compliant/unsafe 902A. A boundary 908A separates concrete scenarios with compliant/safe 904A AV responses and non-compliant/unsafe 902A AV responses. In an example, the first metric corresponding to surface 910 represents the behavior of the AV in concrete scenarios with an AV and a pedestrian. Concrete scenarios where the AV causes a traffic conflict with the pedestrian are considered unsafe 902A, and scenarios where the AV does not cause a traffic conflict with the pedestrian are considered safe 904A. Similarly, the surface 920 represents a second metric where the response of an AV to concrete scenarios is identified as compliant/safe 904B or non-compliant/unsafe 902B. A boundary 908B separates concrete scenarios with compliant/safe 904B AV responses and non-compliant/unsafe 902B AV responses. In examples, the second metric corresponding to surface 920 represents the behavior of the AV in concrete scenarios with a traffic event such as a road departure. For example, concrete scenarios where the AV leaves the road are considered unsafe 902B, and scenarios where the AV remains on the road are considered safe 904B.

Surfaces 910 and 920 corresponding to a first metric and a second metric are combined to create a domain volume 930. In examples, the domain volume is the same as or similar to volumes 510 of FIG. 5. A total boundary 930 is determined for the volume 930. In examples, the total boundary 930 separates the concrete scenarios that are identified as safe in surfaces of the volume from the concrete scenarios that are not identified as safe throughout the volume. Accordingly, the area 904C corresponds to concrete scenarios that are indicated as safe at the surface 910 and the surface 920. The area 906 corresponds to concrete scenarios that are indicated as unsafe at the surface 910. The area 902C corresponds to concrete scenarios that are indicated as unsafe at the surface 910 and the surface 920. The area 907 corresponds to concrete scenarios that are indicated as unsafe at the surface 920.

In some embodiments, a total boundary is a combination of boundaries for each respective surface of the volume. In the example of FIG. 9, the resulting total boundary 930 of the volume is a combination of the boundaries associated with the surface 910 corresponding to the first metric and the surface 920 corresponding to the second metric. Thus, the volume boundary covers multiple metrics applied to concrete scenarios in a parameterized scenario space. Metrics can be of any data type, such as binary metrics, continuous metrics, or any combinations thereof. Binary metrics have two states (e.g. traffic conflict/no traffic conflict; traffic event/no traffic event). Continuous metrics have an infinite amount of states (e.g., acceleration can take any value between 0 and infinity). Changes in the metrics are observed over time, and a total boundary is iteratively determined multiple times during the development of an autonomous system. By comparing the metrics at different times (e.g., at times involving the use of different versions of a software stack of an autonomous system) the present techniques track how safety performance of the autonomous system changes across time. In embodiments, the total boundary corresponding to multiple metrics is determined without simulating the concrete scenarios in the domain volume. Instead, multiple metrics are explored simultaneously, and the total boundary determined via active learning. In this manner, concrete scenarios are selected near the total boundary that are informative for multiple metrics. The concrete scenarios along the total boundary are simulated to evaluate the autonomous system. The simulations at the autonomous system are used to determine if the autonomous system performs safe and/or meets promulgated safety standards.

Traditionally, verification that the autonomous vehicle performs safely and is compliant is performed by executing individual test cases in a domain. However, this makes it difficult to extrapolate findings from the individual case to the entire domain. The present techniques use active learning to evaluate a test space with a plurality of metrics. Active learning enables precise feedback during the development cycle. In embodiments, the present techniques are able to determine what causes shifts in the boundary.

Determining the boundary between compliant and non-compliant volumes is useful for development and debugging of an autonomous system. Another technical advantage of the present techniques is using a fewer number of samples when compared to parameter sweeps during development and debugging. In addition to identifying boundaries between a plurality of metrics of different types, the present techniques assign hierarchies to the metrics. In some embodiments, the hierarchies of metrics are correlated to hierarchies of rules that are applied to autonomous driving functionality. For example, a lower level rules are comfort rules. Comfort rules may be, for example, rules that create comfort for the occupants of the vehicle. At a higher level in a hierarchy, road rules are implemented to create orderly travel by the autonomous vehicles. At the highest level are rules that prevent harm. Rules that prevent harm are rules that prevent the autonomous vehicle from causing traffic conflicts with pedestrians, vehicles, or other agents in the environment. It is preferable to violate a lower level rule when compared to higher level rules. For example, the autonomous vehicle can drive more uncomfortably if that enables compliance with road rules. In another example, the autonomous vehicle can purposefully break a road rule in order to avoid a traffic conflict with a pedestrian. With a hierarchy of rules, the compliance or verification associated with the rule is based on the highest level of rules that are violated in a particular scenario. In examples, a violation of lower priority rules is expected in some scenarios.

In embodiments, at least one rule is used to guide the metrics. For example, when metric is a threshold or range, response values outside of the threshold or range enables a determination of if a corresponding rule is violated. For example, a metric is threshold distance between the AV and a closest agent. By applying a threshold (e.g., a particular distance) the rule is verified. In embodiments, the present techniques explore the metrics that underlie a hierarchical rule structure. In embodiments, there is a one-to-one mapping between the rules and the metrics. The metric enables evaluation of a corresponding rule to determine if the AV is compliant or noncompliant.

In some embodiments, the rules form Rulebooks, a collection of foundational rules derived mathematically and defined to determine the safest action possible with minimal violation of the rules. The Rulebooks provide a structure for comparison between metrics of different types. In examples, the rules (e.g., Rulebooks) translate laws and other objectives to cost formula in an explicit hierarchy. The extent of violation of the rules is quantified. For example, for a binary metric, a boundary is identified based on the value of the binary metric (e.g., pass or fail). For a continuous metric, a threshold level or range is evaluated to identify the boundary associated with the continuous metric. This a proxy for rules in the Rulebooks, and levels associated with metrics can be derived from the rules. In examples, the rules define a limit under which the AV is in compliance with the rule, and if the limit is not met then the AV is not compliant with the rule. In embodiments, the metric is a quantification of the limits.

Thus, the present techniques enable exploration of a combination of binary and continuous metrics in a same parameterized scenario space. The combination is realized through the application of several exploration algorithms. In embodiments, multiple algorithms are used due to the different algorithms for the binary and the continuous metrics. However, the present techniques are not limited to the algorithms described herein. Through the multiple algorithms, the present techniques identify compliant and non-compliant domain volumes, including the boundaries that separate the compliant domain volume from the non-compliant domain volume. Scenarios are identified near the boundary from both compliant and non-compliant domain volumes. The present techniques extend active learning approaches to combinations of binary and continuous metrics, or trip functions, or rules.

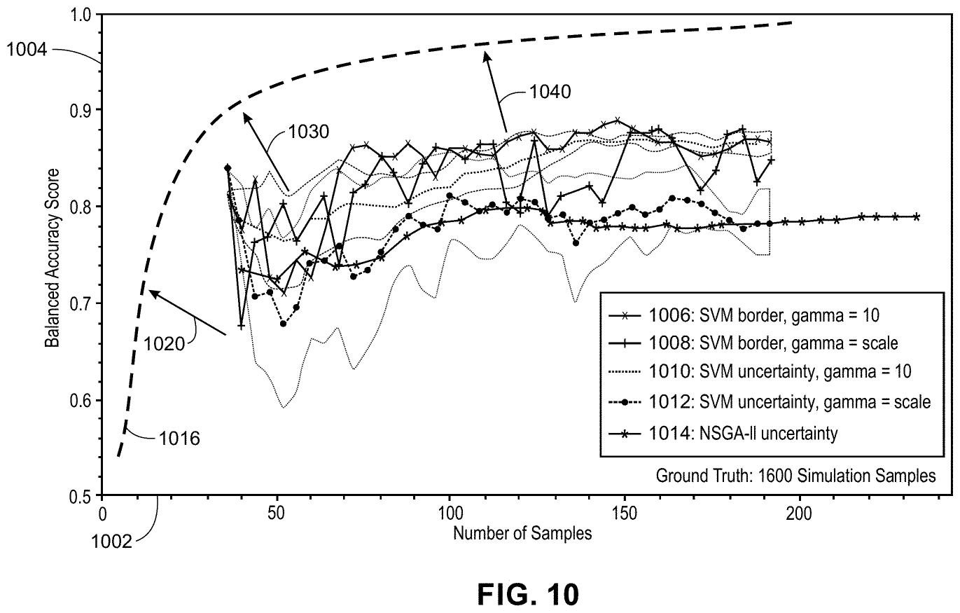

FIG. 10 is an illustration of quality of the boundary estimates vs number of samples. In embodiments, exploration algorithms are compared by determining which one classifies the most points correctly with the fewest samples necessary as illustrated by FIG. 10. In embodiments, the exploration algorithms are variations of active learning systems, such as the active learning system illustrated in FIG. 4B.

In the example of FIG. 10, line 1006 as corresponds to an SVM border, with a gamma=10; line 1008 corresponds to an SVM border, with a gamma=scale; line 1010 corresponds to an SVM uncertainty, with a gamma=10; line 1012 corresponds to an SVM uncertainty, with a gamma=scale; and line 1014 represents a Non-dominated Sorting Genetic Algorithm II (NSGA-II), a genetic algorithm baseline.

In FIG. 10, the x-axis 1002 corresponds to the number of samples, while the y-axis 1004 corresponds to a balanced accuracy score. Dashed line 1016 represents an ideal accuracy score versus the number of samples, where accuracy quickly increases for small number of samples at reference number 1020. As the number of samples increases, the accuracy increases as shown at reference number 1030, and the asymptotically reaches an accuracy score of one with a high number of samples at reference number 1040.

FIG. 11 shows a ground truth surface 1100. The present techniques compare regions of safe behaviors in with high dimensional data. In the example of FIG. 11, the boundaries between regions for multiple metrics are fit with basic geometric shapes, such as a line that identifies the boundaries between metric A and metric B. For three or more metrics, boundaries can be expressed as three dimensional planes in the parameterized scenario space. In higher dimensions, the boundaries are expressed as some particular high dimensional shape. The ground truth surface is determined by discretizing the parameter space and executing simulations on every cell to collect the ground truth of compliance/non-compliance

In the example of FIG. 11, the x-axis 1102 represents the agent distance from the intersection, and the y-axis represents the agent velocity. Concrete scenarios are shown with X and O characters on the ground truth surface 1100. In the example of FIG. 11, a linear boundary with 95% safe scenarios 95% confidence is illustrated. Area 1110 represents compliant scenarios. Area 1112 represents the non-compliant scenarios.

The lines 1114A, 1114B, 1116A, and 1116B are a visualization of the improvement/regression of the result to a baseline. The dashed lines 1114A and 1114B represent the linear boundary where there is at least 95% compliant scenarios with 95% confidence. The solid lines 1116A and 1116B represent a linear boundary of a baseline. The relative orientation of these lines are used to compare the improvement between current stack and baseline.

Safety Verification

In embodiments, once the exploration algorithms have obtained the compliant domain volumes, non-compliant domain volumes, and total volume boundary, safety verification is implemented using the compliant domain volumes. By exploring the compliant domain volumes, the present techniques intelligently select concrete scenarios for simulation that replicate the vast situational variance encountered over the ODD. The selected concrete scenarios enable a precise, expressive representation in behavioral requirements and quantified good/bad behavior of an autonomous system.

The safety verification extends the Rulebooks methodology to verify the Road vehicles—Safety of the intended functionality (SOTIF) International Standards Organization (ISO) 21448 over the compliant domain volume. In embodiments, the compliant domain volume is identified via simulation sampling. In simulation sample, a simulation is executed and the compliance for a concrete set of parameters is verified. The AV satisfies intended functionality over scenario space if and only if the AV compliant domain volume (found via testing) encloses required compliant domain volume (manually specified). The domain volume covers one or a combination of metrics, and is not limited to solely metrics associated with the occurrence of traffic conflicts. In some embodiments, domain volumes are provided with corresponding confidence measures, and a compliance confidence is quantified. In embodiments, the process is repeated over sufficient scenario spaces to cover the ODD.

In some embodiments, compliant domain volumes are compared. In embodiments, the present techniques enable verification of satisfying SOTIF by (hyper-dimensional) volume comparison rather than collection of single points (traditional scenario-based validation). Additionally, the methodology can apply to other complex system verification aside from autonomous driving use cases. In embodiments, the present techniques quantify the gaps in coverage for situations where the autonomous system's compliant domain volume is unable to cover the entire required compliant domain volume.

Search Algorithms and Safety Verification for Compliant Domain Volumes: Autonomous Vehicle Example

A sample efficient method for discovering the boundary between compliant and non-compliant behavior via active learning is described. Given a logical scenario, one or more compliance metrics, and a simulation oracle, the compliant and noncompliant domains of the scenario are mapped. The methodology enables critical test case identification, comparative analysis of different versions of the system under test, as well as verification of design objectives. In examples, a logical scenario is defined that includes a jaywalker crossing in front of an autonomous vehicle. Boundaries are obtained for at least one metric. In this example, the metrics include traffic conflict, lane keep, and acceleration metrics, as well as combinations of them. The present techniques evaluate these metrics with substantially less (e.g., six times less) simulations when compared with traditional techniques such as a parameter sweep. In examples, the present techniques are also used to detect and rectify a failure mode for an unprotected turn scenario with only 86% fewer simulations when compared with traditional techniques.

As described above, continuous safety assessment of the capabilities of safety-critical autonomous systems is a key part of their development process. Some autonomous systems, such as AVs, operate in complex uncertain environments and their behavior needs to generalize across newly encountered situations. This necessitates careful analysis of their performance. The performance is described in the context of an ODD, a specification of the conditions under which the system should operate safely. Furthermore, the system performance can be specified by one or more desired behaviors (rules) each associated with a compliance metric that measures to what extent the system exhibits the desired behavior. Compliance metrics can be either binary (safe/unsafe) or continuous (degree of compliance).

Autonomous systems are designed to exhibit has safe behavior throughout the ODD. However, reaching such levels of confidence is usually a highly resource and time-consuming iterative process. In order to assess the current state of the autonomous system under test and to inform the future development iterations one needs to know in which parts of the ODD the system is currently compliant with a rule and in which it needs further improvements.

The boundary between compliant and non-compliant behavior is therefore invaluable for the development process. Compliance boundaries are usually located in sensitive regions of the ODD. Small perturbations close to these boundaries tend to change the system's discrete state variables. Hence, they can result in significant differences in behavior. Therefore, compliance boundaries provide valuable feedback by: highlighting critical test cases for further root-cause analysis and fault identification; demonstrating compliance by showing that the compliant domain fully contains the ODD; and tracking the performance change across the development process by means of compliance boundary shifts.

Evaluating regions of unsafe behavior and their boundaries may be unsafe, and not performed on the physical system. Simulations enable evaluation of autonomous systems without creating unsafe conditions. In examples, a library of concrete scenarios that correspond to points in the ODD is simulated and used to evaluate the current state of the system. Yet, testing single ODD points can lead to missing potential safety issues in their neighborhood. Alternatively, one could partition the ODD into logical scenarios each containing similar concrete scenarios. The pace of autonomous system development depends on the lag time from feature introduction to the identification of bugs and limitations. Reducing the number of simulations needed can thus speed up the development process and reduce the associated costs and the environmental impact. Consequently, there is a need for sample-efficient methods for discovering compliance boundaries in logical scenarios.

To address discover compliance boundaries of a logical scenario in a sample-efficient manner, a framework is created where, given a logical scenario with its set of parameters, a set of rules and corresponding compliance metrics, and an oracle, the most informative concrete scenarios (parameter values) are sequentially selected to query the oracle. This constitutes an active learning problem. The scenario queried is the one maximally reducing the ambiguity (a notion of uncertainty) of the boundary for a single metric, for the combined compliance of two or more metrics, or for the identification of the most critical metric violation. The framework then provides an estimate of the compliance boundary and a set of concrete scenarios lying on both the compliant and non-compliant sides of the boundary. The boundary estimate can then be used to evaluate which parts of the ODD meet the design objectives or for comparative analysis with other versions of the system. Moreover, further investigation of the provided critical cases can guide the developer to identify the root-cause of the non-compliance. Thus, the present techniques include a general sample-efficient method for critical test case identification and compliance boundary estimation of logical scenarios with binary and continuous metrics. In examples, the framework is implemented using multiple active learning algorithms, and extends to combinations of violation metrics as well as importance hierarchies of the metrics.

In some embodiments, the present techniques hone in on the scenarios located near the boundary. In examples, exploration algorithms such as Gaussian processes and SVMs are employed to explore the boundary. In some embodiments, the exploration algorithms include theoretical guarantees on performance, this is relevant for safety analysis of the autonomous system.

In some embodiments, the present techniques comply with a number of legal requirements, good practices, and mission and comfort requirements. For instance, even if an AV has no admissible course of action, it still has to select which inadmissible action to take. Handling both probabilistic and vague requirements during the design stage can be done via probabilistic model checking and fuzzy logic. The Rulebooks framework provides a more comprehensive hierarchical setting permitting partial rule violations. Rule violations are managed via a hierarchy of rules and violation metrics. Violations of lower-priority rules (e.g. drive smoothly for AVs, maximize production output for industrial robots) are then preferred to violations of high-priority rules (e.g. prevent impact with other road users or objects, meeting minimum manufacturing quality requirements).

Given a logical scenario with d parameters, its domain D⊂R^{d} is the parameters indexing its concrete scenarios. A finite subset of the domain C⊂D, called query candidates is defined. C would often be a discrete grid of points in D but other settings are also possible.

The behavior specification of the autonomous system is represented as a finite nonempty set of rules R. Each rule has an associated violation metric. A binary violation metric is an unknown function m: D→B which induces a partition of D into a compliant subset Dₘ^{C}={p∈D|m(p)=t} and a non-compliant subset Dₘ^{N}={p∈D|m(p)=f}. Examples of binary violation metrics for AVs are no traffic conflict with other road actors, stopping at a stop sign, reaching the mission goal. Similarly, a continuous violation metric is an unknown function m′: D→R, and a threshold t_{m′}, inducing a compliant subset D_{m′}^{C}={p∈D|m′(p)≤t_{m′}} and a noncompliant subset D_{m′}^{N}={p∈D|m′(p)>t_{m′}}. Examples of continuous violation metrics are excess velocity (thresholded against the speed limit) and excess acceleration (with respect to a maximum comfort value). A continuous metric can be transformed into a binary one, though this prevents the learner from steering away from regions with violation values far from t_{m′}. Setting m(p)=f and m′(p)>t_{m′} to be the non-compliant values is arbitrary. The violation metrics for the scenario are M=M_{B}∪M_{R}, with M_{B}⊂B^{D} and M_{R}⊂R^{D} denoted respectively the sets of binary and continuous metrics. In some embodiments, there exists a bijection between R and M mapping each rule to its corresponding metric.

In embodiments, points in C are selected that are close to the boundary between Dₘ^{C} and Dₘ^{N}. for a given metric m by evaluating only a subset of them. Evaluating a concrete scenario p∈D amounts to querying an oracle for metric values m(p) for all m∈M. Driving simulators interfacing with the system under study can act as the oracle for AVs, while industrial robot simulators could act as the oracle in manufacturing.

Depending on the objective (e.g., metric) and whether R is endowed with additional structure, several exploration procedures are enabled. The exploration procedure corresponds to a data type of the metric. An exploration algorithm is assigned to a sub-type of the metric. In a single rule exploration procedure, |R|=1 and there is only one metric m, which can be either binary or continuous metric sub-type. The boundary between Dₘ^{C} and Dₘ^{N} is determined. In a collection of rules exploration procedure, |R|>1, and the compliance of the system relative to each separate rule is evaluated according to its respective metric sub-type. The boundaries between Dₘ^{C} and Dₘ^{N} for all m∈M are determined. In a combination of rules exploration procedure, |R|>1 and the total compliance of the system is evaluated. The boundary between Dₘ_{ₜₒₜ}^{C} and Dₘ_{ₜₒₜ}^{N} is determined, where

$$m \text{?} ( p ) = {∧}_{m ∈ ℳ} Δ ( m ( p ) ) , \qquad ( 1 )$$

$$\text{?} \text{indicates text missing or illegible when filed}$$

With Δ being the compliance verification function

$$Δ ( m ( p ) ) = \{ \begin{matrix}m ( p ) & if m ∈ ℳ \text{?} \\ m ( p ) \leq {t}_{m} & if m ∈ ℳ \text{?}\end{matrix}$$

$$\text{?} \text{indicates text missing or illegible when filed}$$

Note that in this exploration procedure, values are obtained for all metrics in M when a concrete scenario is evaluated, and IMI individual boundaries are estimated (e.g., the boundaries of the individual concrete scenarios). In some embodiments, the present techniques obtain a high quality estimate for the total boundary (e.g., total boundary 908C of FIG. 9), rather than IMI boundaries.

In a hierarchy of rules exploration procedure, each rule has a respective priority as described above. For example, some rules are more important than others. In an example of an AV, compliance with safety rules is prioritized over compliance with comfort rules. Given a total order<over the rules R, the highest priority rule violated for every scenario in D is estimated. This can be represented as the boundaries at which the function m switches values:

$$m : D ↦ M ⋃ \{ T \} \qquad ( 2 )$$

$$P ↦ \{ \begin{matrix} & m if ∃ m , s . t . ¬ Δ ( m ( p ) ) and \\ & ∄ {m}^{′} > m , s . t . ¬ Δ ( {m}^{′} ( p ) ) , \\ ⊤ & otherwise ,\end{matrix}$$

with τ being the case when all rules are satisfied. In some embodiments, a partial order≤over R is considered if for each equivalence class of rules their combination (Equation (1)) is determined as a single level in the hierarchy.

The framework described herein is operable to, given a logical scenario with its set of parameters, a set of rules and corresponding compliance metrics, and an oracle, output an estimate of the compliance boundary and a set of concrete scenarios lying on both the compliant and non-compliant sides of the boundary. At iteration i the framework as described herein picks p∈C{Xᵢ, maximizing an ambiguity function for the compliance metric.Xᵢ are the previously selected points. The definition of ambiguity is determined by the choice of active learning algorithm. Ambiguity functions are described for active learning algorithms for continuous and binary metrics. The framework is agnostic to the specific algorithm choice thus other active learning algorithms can be used instead.

Once p is selected, the corresponding concrete scenario is processed by an oracle (e.g., oracle 424 of FIG. 4B) to determine the value m(p) of every compliance metric m E M using an exploration procedure and algorithm corresponding to a metric data type and sub-type. The estimate of the response surface for each metric is updated, and a new point to simulate is selected. In some embodiments, the update to response surface is based on all metrics, and a determination of where to query next is based on the particular metric. A negligible cost of metric evaluation and response surface is assumed in comparison to the cost of simulation. When considering multiple rules, the framework takes turns picking the highest ambiguity point for each of them. The exploration is further guided by controlling which query candidate points are considered. This depends on whether the overall objective is to evaluate the collection, combination, or hierarchy of the rules. The framework is agnostic to the exploration algorithm choice. In some embodiments, the framework can be modified to fit their specific testing and verification standards via the boundary and exploration selection functions ξᵢ^{b}, ξᵢ^{e} in Algorithms 1 and 2 described below.

In the single rule with a continuous metric exploration procedure, the compliance boundary of a single rule with a continuous associated metric m_{c} is explored. This is equivalent to finding the level set of m_{c} at the threshold tₘ_{_{c}}. Gaussian Processes (GPs) feature flexible response surface estimation principled uncertainty quantification.

A Gaussian Process is a collection of random variables, any finite subset of which is distributed as a multivariate Gaussian. At every point x, the GP defines a mean μₓ and variance σ²(x) of the values of the sampled functions at x. The smoothness of the sampled functions (and their mean) is governed by the kernel choice k(x,x′) . Popular choices are the Radial-basis function (RBF) kernel and the Matern kernel. Assuming a zero-mean prior, N sampled locations X=|x₁, . . . ,xₙ, measurements Y=|y₁, . . . , yₙ|^{T}, and a kernel k, the posterior mean and variance are:

μ(x)=k(x)^{T}(K+σ²I)⁻¹Y

σ²(x)=k(x,x)−k(x)^{T}(K+σ²I)⁻¹k̅(x), (3)

with

k̅(x)=[k(x₁,x),I,k(xₙ,x)],

K_{i,j}=k(xᵢ,xⱼ).

The complexity of fitting a GP is O(N³), which is negligible in practice compared to the simulation time.

One approach to level set estimation is the LSE algorithm. Given an accuracy parameter ϵ∈R₀ and a confidence parameter δ∈(0,1), LSE maintains confidence regions for all points in C which are updated as more points are sampled. Points with confidence regions lying entirely above tₘ_{_{c}}−ϵ are labeled as higher than the threshold and those with confidence regions lying entirely below tₘ_{_{c}}+ϵ are labeled as lower. The rest are considered yet unknown. At iteration i, the next sample location is the next unknown location with the highest ambiguity aᵢ^{LSE}(p)=max{maxJᵢ(p)−tₘ_{_{c}},tₘ_{_{c}}−minJᵢ(p)} where

$${J}_{i} ( p ) = {⋂}_{{i}^{′} = 1 , … , i} [ {μ}_{{i}^{′}} ( p ) = \sqrt{β ( {i}^{′} )} {σ}_{{i}^{′}} ( p ) ] , \qquad ( 4 )$$

is the intersection of all confidence intervals computed at p for previous iterations, including i. The posterior μ_{i′}, and σ_{i′} are obtained by conditioning on the first i′ samples and the interval half size is β(i)=2log(|C|π²i²/(6δ)). The algorithm terminates when there are no unknown points in C left. It is formally described in Algorithm 1 with ξᵢ^{b}=ξᵢ^{e}=aᵢ^{LSE}, T=GP. The LSE's objective is to minimize the error in the space of the range of m_{c} rather than the error in locating the boundary (the domain space of m_{c}).

In some embodiments, the exploration algorithm is a Gaussian Processes Regression with Boundary Exploitation and Space-Filling (GPR-BE-SF), with an explicit exploration-exploitation trade-off regime with the exploitation focusing exclusively on the safety boundary. The algorithm selects the most space-filling point, i.e., the maximizer of aᵢ^{SF}(p)=min_{x∈X}_{ᵢ}∥p−x∥. The exploitation mode of GPR-BE-SF refines the current compliance boundary by sampling a point close to it, that is, the minimizer of aᵢ^{BE}(p)=| |. The chosen mode depends on how far the particular stage in the exploration process: early exploration is performed to find all non-compliant regions and to obtain a rough boundary estimate, while later this estimate is refined. To control the trade-off between the two modes, iteration i samples are taken at the border with probability

$$τ ( i ) = tanh ( \frac{2 i}{N} ) ,$$

where N is the total number of iterations allocated. Other functions with horizontal asymptotes 0 and 1 at respectively 0 and N can be used in place of tanh. A small set of points I⊂C, usually a sparse grid, are simulated to initialize the first posterior. The single metric boundary detection is presented in Algorithm 1, with ξᵢ^{b}=−aᵢ^{BE} and ξᵢ^{e}=−aᵢ^{LSE}, and T=GP .

Algorithm 1: Single metric boundary detection

| | |
|---|---|
| input : | Candidates C, initial points I ⊂ C, method T, |
| | iterations N, boundary and exploration selection |
| | functions ξᵢ^{b}, ξᵢ^{e}, metric evaluation interface m |
| output: | Sample locations X_{N} and values Y_{N} |

| 1 | for i ← 1 to \|I\| do xᵢ ← Iᵢ, yᵢ ← m(xᵢ) : | |
|---|---|---|
| 2 | for i ← \|I\| + 1 to N do | |
| 3 | \| Xᵢ ← {x₁,...,xᵢ₋₁}, Yᵢ ← {y₁,...,yᵢ₋₁}: | |
| 4 | \| switch T do | |
| 5 | \| \| case GP do | |
| 6 | \| \| \| Get μᵢ, σᵢ² by fitting a GP with Xᵢ, Yᵢ; | // Eq 3 |
| 7 | \| \| case SVM do | |
| 8 | \| \| \| Get wᵢ by fitting an SVM with X_{i,} Yᵢ; | // Eq 5 |

| | |
|---|---|
| 9 | \| \| end |
| 10 | \| end |
| 11 | \| τ ← tanh(2i/N); sample \ddot{τ} ~ U[0, 1]; |
| 12 | \| if \ddot{τ} < τ then |
| 13 | \| \| xᵢ ← arg max_{p∈C\} xᵢ ξᵢ^{b}(p), yᵢ ← m(xᵢ) |
| 14 | \| else |
| 15 | \| \| xᵢ ← arg max_{p∈C\} xᵢ ξᵢ^{e}(p), yᵢ ← m(xᵢ) |
| 16 | \| end |
| 17 | end |
| 18 | X_{N} ← {xᵢ,...,x_{N}}, Y_{N} ← {y₁,...,y_{N}}: |

In some embodiments, a_{SF} does not utilize the uncertainty information supplied by the GP posterior. Hence it might sample unnecessarily in vast regions which are known with high probability to be far from tₘ_{_{c}}. In some embodiments, a modification of the algorithm, GPR-BE-LSE, is defined, based on LSE. Keeping everything else the same, the exploration objective is changed from aᵢ^{SF} to aᵢ^{LSE} (Equation(4)). GPR-BE-LSE corresponds to Algorithm 1 with ξᵢ^{b}=−aᵢ^{BE} and ξᵢ^{e}=aᵢ^{LSE} and T=GP.

In a single rule with a binary compliance metric m_{b} exploration procedure two algorithms are outlined, an algorithm based on Support Vector Machines (SVMs) and an algorithm based on GPs.

An SVM is solving for the best separating hyperplane between two classes of samples or the embeddings via a kernel k satisfying the Mercer's condition. Best separation is achieved by maximizing the distance from the boundary to the samples closest to it. Soft-margin SVMs relax this condition by allowing misclassification of some samples as a trade-off between the quality of the fit and the smoothness of the resulting boundary. Formally, a soft-margin SVM is defined as:

$${min}_{w , ζ} \frac{1}{2} {w}^{⊤} w + {C}^{′} {\sum }_{i = 1}^{N} {ζ}_{i} , \qquad ( 5 )$$

$$subject to {y}_{i} ( {w}^{⊤} ϕ ( {x}_{i} ) ) \geq 1 - {ζ}_{i} ,$$

$${ζ}_{i} \geq 0 , i = 1 , … , N ,$$

where w is the normal to the hyperplane in the embedding space, ζ is a vector of slack variables, yᵢ∈{−1, +1} is the label for sample Xᵢ, C′ is a regularization parameter for the smoothness-mislabeling trade-off, and ϕ is an implicitly defined embedding function for the kernel whose existence follows from Mercer's theorem.

The SVM-based active learning selects the closest previously unsampled point to the current boundary estimate wᵢ, that is the minimizer of the decision function aᵢ^{DF}(p)=wᵢ^{T}ϕ(p). This results in refining the boundary estimate and is also supported by theory, as it approximates choosing the point that halves the volume of the space of hyperplanes that fit the data. This algorithm is referred to as SVM-DF. In this case, there is no additional explicit exploration, and SVM-DF corresponds to Algorithm 1 with ξᵢ^{b}=ξᵢ^{e}=−aᵢ^{DF}, T=SVM. Alternatively, sampling the decision function minimizer can be combined together with the space-filling explorer, which is called SVM-DF-SF. This corresponds to Algorithm 1 with ξᵢ^{b}=−aᵢ^{DR}. ξᵢ^{e}=aᵢ^{SF}, T=SVM.

In some embodiments, Gaussian Processes Classification (GPC) is used in a similar way to enable active learning. GPC is a probabilistic classification algorithm that uses a latent GP to probabilities with, for example, the logistic function f(x)=(1+e^{-x})⁻¹, resulting in probabilityπm(p) of the point p being from the positive class. Hence the border at iteration i is the 0.5 level set of πᵢ, or equivalently, the 0 level set of μᵢ. This procedure is referred to as GPC-P-SF. Concretely, that is Algorithm 1 with ξᵢ^{b}=aᵢ^{P} and ξᵢ^{e}=aᵢ^{SF}, T=GP, where aᵢ^{p}(p)=|(μᵢ(p)−0)|.

Thus the examples describe exploration procedures that find the compliance boundary for a single rule. In some embodiments an autonomous system needs to comply with a collection of rules R. An single metric exploration procedure as described above can be independently applied for each rule, though that would require |R| times the number of samples. In some embodiments, samples chosen by the exploration of one of the metrics are used to update the estimates for the other metrics as well.

In a collection of rules exploration procedure, a turn-taking algorithm M−TT is employed. Given a set of metrics M, M−TT iterates which leaner it queries for the next location but evaluates the metrics for all rules and updates the estimates for all the learners. This corresponds to Algorithm 2 with A=M−TT.

Algorithm 2: Multi-metric boundary detection

| | |
|---|---|
| input : | Candidates C, initial points I ⊂ C, algoothm A, |
| | iterations N, selection functions ξᵢ^{b, m}, ξᵢ^{e, m} and methods |
| | T^{m} for all metric evaluation interfaces m ∈ [symbol] |
| output: | Sample locations X_{N} and values Y_{N}^{m}, ∀m ∈ [symbol] |

| 1 | for i ← 1 to \|I\| do xᵢ ← Iᵢ, yᵢ^{m} ← m(xᵢ), ∀m ∈ [symbol] ; | |
|---|---|---|
| 2 | for i ← \|I\| + 1 to N do | |
| 3 | \| Xᵢ ← {x₁,...,xᵢ₋₁}, Yᵢ^{m} ← {y₁^{m},...,yᵢ₋₁^{m}}, ∀m ∈ [symbol] ; | |
| 4 | \| for m ∈ [symbol] do | |
| 5 | \| \| Fit Xᵢ, Yᵢ^{m} with Tₘ, ξᵢ^{b, m}, ξᵢ^{e, m}; | // Alg. 1, lines 4 to 10 |

| 6 | \| end | |
|---|---|---|
| 7 | \| \ddot{m} ← [symbol] [1 + i mod \| [symbol] \|]: | // for a fixed sequence on [symbol] |

| | |
|---|---|
| 8 | \| switch A do |
| 9 | \| \| case M-TT do Qᵢ ← Cᵢ/Xᵢ; |
| 10 | \| \| case M-C do Qᵢ ← (Cᵢ/Xᵢ)_{∩}∩_{m∈} [symbol] D_{m′}^{C},i; |
| 11 | \| \| case M-H do Qᵢ ← (Cᵢ/Xᵢ)_{∩}∩_{m′>m} D_{m′}^{C},i; |
| 12 | \| end |
| 13 | \| τ ← tanh(2i/N); sample \ddot{τ} ~ U[0, 1]; |
| 14 | \| if \ddot{τ} < τ then |
| 15 | \| \| xᵢ ← arg max_{p∈Q}_{ᵢ} ξᵢ^{b, m} (p) |
| 16 | \| else |
| 17 | \| \| xᵢ ← arg max_{p∈C/X}_{ᵢ} ξᵢ^{e, m}(p) |
| 18 | \| end |
| 19 | \| yᵢ^{m} ← m(xᵢ), ∀m ∈ [symbol] |
| 20 | end |
| 21 | X_{N} ← {xᵢ,...,x_{N}}, Y_{N}^{m} ← {y₁^{m},...,y_{N}^{m}}, ∀m ∈ [symbol] ; |

In some embodiments, higher-accuracy estimates for the boundary of all rules being compliant instead of the compliant domain of individual rules is discovered. This amounts to finding the compliance boundary for the binary-valued metric mₜₒₜ defined in Equation (1). Naively, one could treat mₜₒₜ like any other binary metric, however, this discards information from the real-valued metrics M_{B} which could otherwise steer the exploration away from regions with metric values far from their respective thresholds. In a combination of rules exploration procedure, an algorithm M−C: an algorithm using M−TT is employed as a base with exploitation restricted to points in ∩_{m∈M} D_{m,i}^{C}, the current estimate of the compliant domain for mₜₒₜ (Algorithm 2 with A=M−C). In some embodiments, space-filling points are selected in the non-compliant regions, preventing an initial bad estimate from irreversibly biasing the exploration. Additionally, in some embodiments, boundary estimates are obtained for all metrics, be it of lower resolution.

Consider the case an order<over the rules is presented and with the question of which is the highest violated rule for a given scenario in the domain is determined. In particular, the boundaries at which the value of m changes is determined. The value of m is defined in Equation (2). In examples, the M−TT algorithm is applied and then the value of m is computed for all sampled locations. This can result in unnecessary sampling around lower-priority metric boundaries known to be in the non-compliant subset of a higher-priority rule. In a hierarchy of rules exploration procedure, an M−H algorithm is employed, which restricts the boundary detection of lower-priority metrics only to the intersection of the current estimates for the compliant domains for the higher-priority rules (Algorithm 2 with A=M−C). Similar to M−C, space-filling points are selected and lower-quality estimates for all metrics are obtained as a by-product.

In embodiments, the framework for exploring parameterized scenario spaces is used for verification of critical systems of an autonomous system, such as an AV. In examples, the framework is executed by a planning system 404. In examples, the present techniques can be applied in the development process of AVs. For purposes of description, two scenarios involving AVs are illustrated. FIG. 12 shows a jaywalker scenario 1210 and an unprotected turn scenario 1220. In the example of the jaywalker scenario 1210, the AV 1214 (whose performance is being studied) is driving on the left lane 1218B of a right-hand-traffic carriageway 1212 with four traffic lanes, two in each direction. In examples, carriageway 1212 (e.g., road) is 14.6 m wide. The right lane 1212A is illustrated. A jaywalker 1216 appears in front of the AV along path 1216A, and crosses the road 1212. The jaywalker enters into the path 1214A of the AV 1214. The longitudinal headway (e.g., how far the jaywalker is from the AV when first detected) is parameterized (p₁∈[0 m, 60 m]). Additionally, the lateral progress (e.g., how far the jaywalker is in crossing the street when first detected) is parameterized (p₂∈[0 m, 10 m]).

In the jaywalker scenario 1210, three separate metrics are observed, in order of importance. First, a primary safety rule metric m_{col}∈B^{D} is to avoid a traffic conflict with the pedestrian. This highest-priority metric is a binary-valued non-conflict metric m_{col} and is violated if minimum distance between the bounding boxes of the AV and the pedestrian is less than 15 cm (buffer reflecting uncertainties). A second traffic rule metric mₗₐₙₑ∈B^{D} is to not leave the current lane. This metric is violated is the bounding box between the AV is 25 cm or more outside of its current lane. A third comfort rule metric m_{acc}∈R^{D} is to drive comfortably for the passenger in the AV. This metric is violated is the absolute acceleration of the AV exceeds a threshold of tₘ_{_{acc}}=1.5 m/s². In some embodiments, a binary version m_{bacc} of this metric defined as m_{bacc}(p)=(m_{acc}(p)≤tₘ_{_{acc}}). In some embodiments, a proprietary planning and control simulator is used to evaluate the concrete scenario p and then extract the compliance metric values by processing the simulator logs (e.g., 710 of FIG. 7).

The query candidates C are a 33×33 grid over p₁ and p₂, with a 6×6 initialization grid I. The coordinates of the points are normalized to the [0; 1] range. As ground truth, the three metrics are evaluated on all 1089 candidate points.

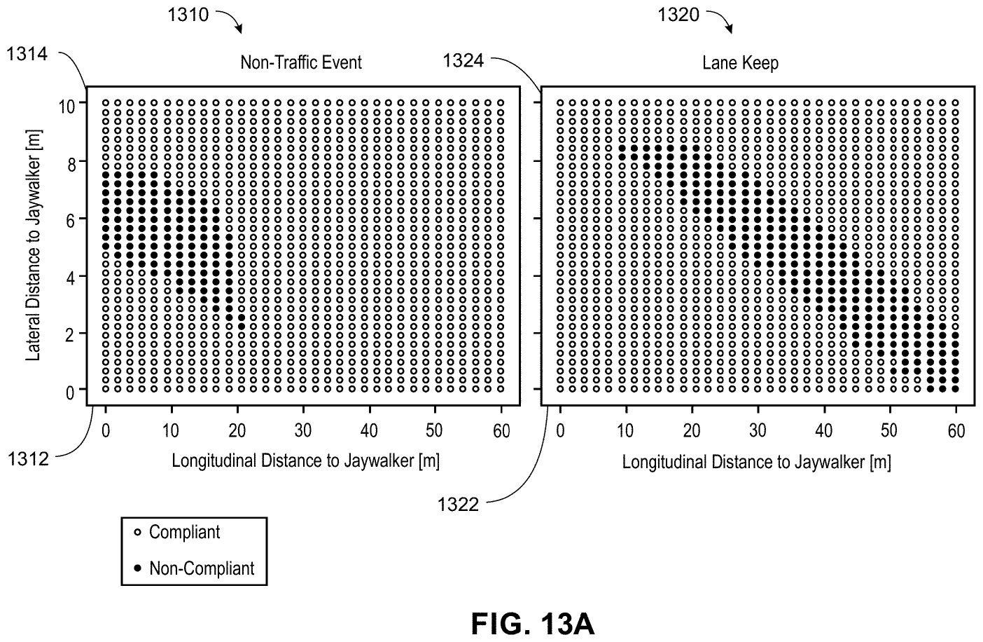

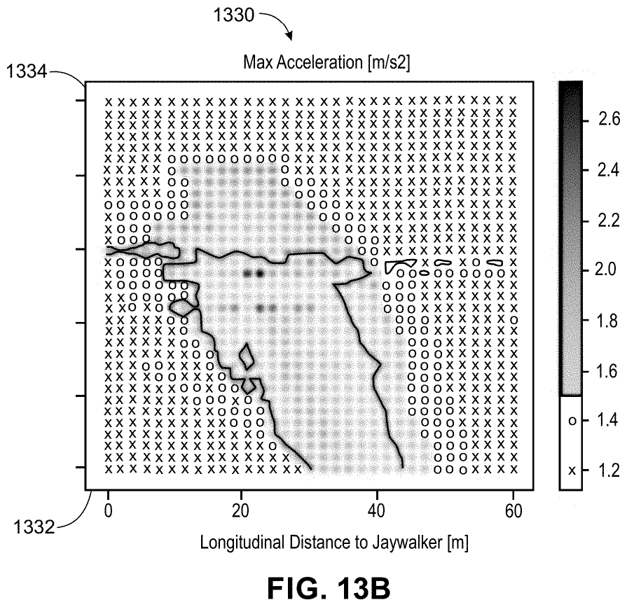

FIGS. 13A and 13B show truth values for the three metrics. At surface 1310, a non-traffic conflict is evaluated. At the surface 1310, the x-axis 1312 represents the longitudinal distance to the jaywalker in meters, and the y-axis 1314 represents the lateral distance to the jaywalker in meters. At surface 1320, a lane keep metric is evaluated. At the surface 1320, the x-axis 1322 represents the longitudinal distance to the jaywalker in meters, and the y-axis 1324 represents the lateral distance to the jaywalker in meters. At surface 1330, a maximum acceleration of the AV is evaluated. At the surface 1330, the x-axis 1332 represents the longitudinal distance to the jaywalker in meters, and the y-axis 1334 represents the lateral distance to the jaywalker in meters.

In examples, when the jaywalker 1216 appears close to the AV 1214 of FIG. 12, and depending on the lateral location of the jaywalker 1216, the AV 1214 might not have enough time to detect and react so a traffic conflict occurs. For lateral starting position far left or to the right of the AV, the jaywalker passes either before or after the ego crosses its path so a traffic conflict is averted. The plot 1320 for mₗₐₙₑ and plot 1330 m_{acc} show that the AV 1214 successfully avoids a traffic conflict with the jaywalker 1216 by decelerating rapidly, changing lanes, or both. If the jaywalker appears far away and in front of the ego or to the left, they would have crossed the road by the time the ego crosses their path so no action beyond mild decelerating is required.

To measure of the quality of the exploration, a Balanced Accuracy Score on Border: Balanced Accuracy Score is computed only over the points lying on the compliance border for the ground truth. A point p is considered to be on the border for metric m if for any p′ in its 3×3 neighborhood it holds that Δ(m(p))≠Δ(m(p′)). In the following examples, compliance boundary detection is described for individual rules, multiple rules, and as used in development.

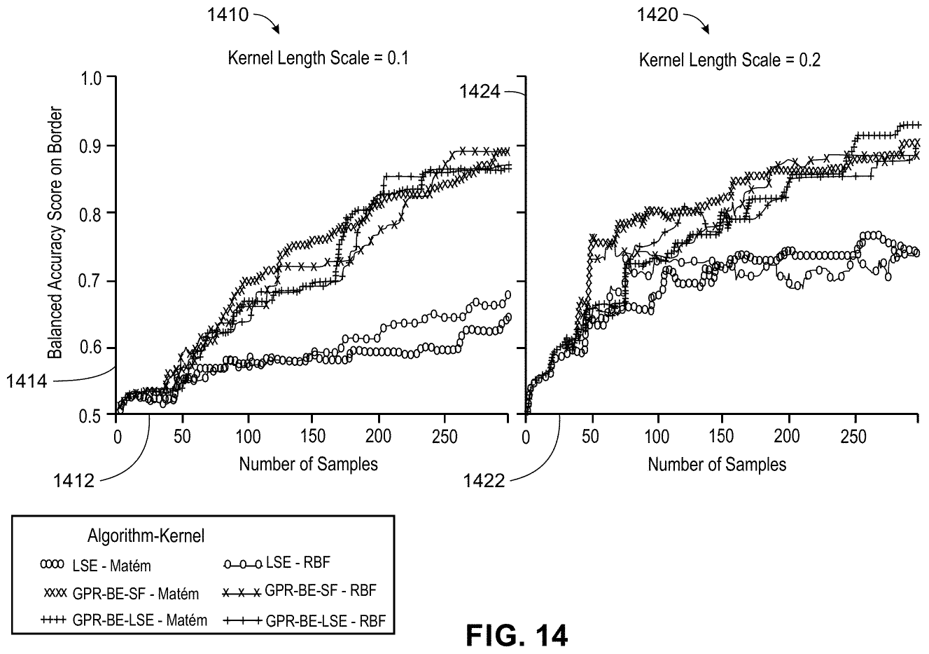

In a first example, compliance boundary detection for individual rules is described. FIG. 14 is a comparison of algorithms for a single continuous metric data type. In the plots shown, the x-axis (1412, 1422) represents the number of samples, and the y-axis (1414, 1424) represents the balanced accuracy score on the border. In the example of FIG. 14, the LSE, GPR-BE-SF, and GPR-BE-LSE are compared for length scales 0.1 (1410) and 0.2 (1420). Further both the RBF kernel and the Matern kernel with a smoothness parameter v=2.5 for a maximum of 300 iterations are illustrated.

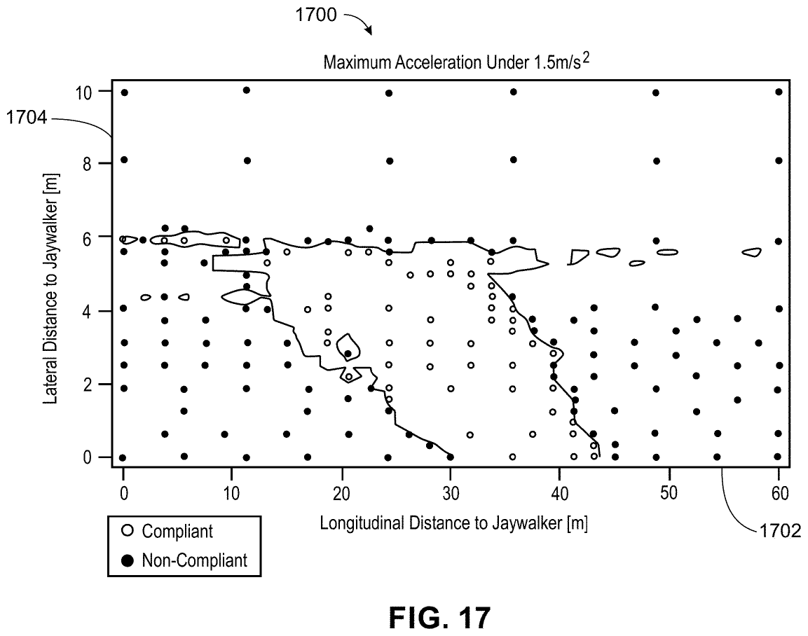

In the example of FIG. 14, GPR-BE-SF and GPR-BE-LSE both outperform LSE across the choices for length scale and kernel. The Matern kernel appears to perform slightly better than RBF, though this could be specific to the scenario. Both GPR-BE-SF and GPR-BE-LSE achieve about 90% correct classification on the boundary by just sampling a quarter of the points. This is already a significant reduction in the time and resources needed for simulation. In practice, however, terminating the exploration process only after about 170 iterations provides sufficiently refined boundaries for development purposes, which is a reduction of computational expenses of about 6.4 times as shown in FIG. 17. FIG. 17 shows a compliance boundary in a jaywalker scenario (e.g., scenario 810 of FIG. 8).

As illustrated in FIG. 14, quality increases as the number of samples nears 1089, the total number of candidate points. However, as the algorithm and its hyperparameters induce a family of models with specific smoothness properties, perfect boundary reconstruction will not be possible if the true response is not from this family. Hence, hyperparameter selection should performed using domain knowledge.

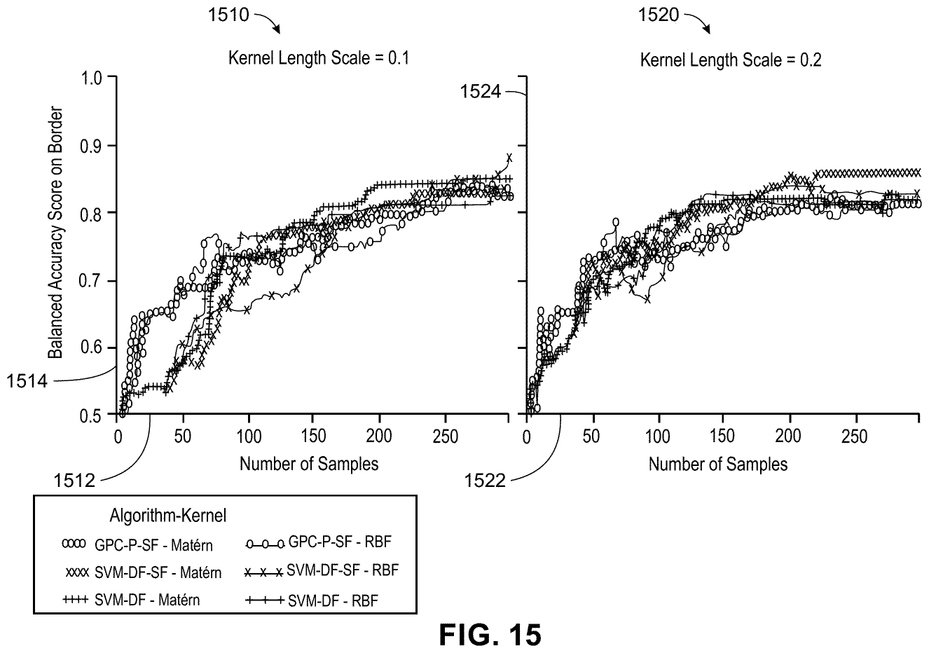

Similarly, FIG. 15 shows a comparison of single binary metric algorithms, GPC-P-SF, SVM-DF-SF, and SVM-DF on the thresholded acceleration metric m_{bacc} for length scales 0.1 (1510) and 0.2 (1520). In the plots shown, the x-axis (1512, 1522) represents the number of samples, and the y-axis (1514, 1524) represents the balanced accuracy score on the border. For the SVM-based algorithms, C′ was set to 10. Unlike the continuous case, all binary algorithms exhibit similar performance. GPC-P-SF appears to be scoring slightly lower than the SVM-based algorithms but the difference appears negligible. For the binary case, about 80% balanced accuracy score is achieved on the boundary by sampling less than a quarter of the candidate points. In FIG. 15, the performance of the binary case appears to be slightly lower than the one for the continuous case, signaling that using metrics with continuous values, when available, is beneficial.

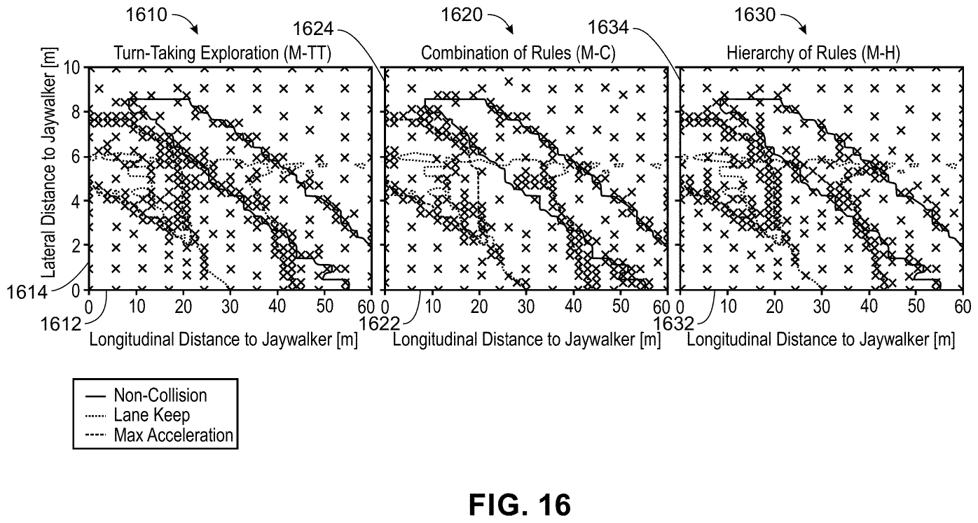

In a second example, compliance boundary detection for multiple rules is described. FIG. 16 shows selected sampling locations marked by X's for the multiple metrics case with the ground truth compliance boundaries plotted for the three metrics. In the plots shown, the x-axis (1612, 1622, 1632) represents the longitudinal distance to the jaywalker, and the y-axis (1614, 1624, 1634) represents the lateral distance to the jaywalker. In the example of FIG. 16, the M−TT (1610), M−C (1620), and M−H (1630), algorithms are illustrated. FIG. 16 shows how the three algorithms result in different sections of the compliance boundaries of m_{col}, mₗₐₙₑ, m_{acc} being explored, as desired. The learner for m_{col} is GPC-P-SF with the Matern kernel, for mₗₐₙₑ is the SVM-DF-SF with RBF, and for m_{acc} is GPR-BE-LSE with Matern, all with length scale 0.2 and ran for 300 iterations.

Comparing the sampling locations selected by M−C and M−TT, FIG. shows that M−C prefers samples on the non-overlapping boundaries and samples less parts of the boundaries that are in the non-compliant domain of other rules. For example, the part of the boundary of m_{col} that is in Dₘ_{_{acc}}^{N} is not as extensively explored as by M−TT. The same holds for the segment of mₗₐₙₑ's boundary that falls in Dₘ_{_{acc}}^{N}. Hence, M−C indeed prioritizes sampling on the border of mₜₒₜ which is precisely the boundary of the union of the three non-compliant regions.

Similarly, comparison with M−TT shows that M−H sampled extensively the border of the highest-importance metric m_{col}, followed by the one for mₗₐₙₑ. This is evident from the increased sampling in the overlapping region of the boundaries of m_{col} and mₗₐₙₑ with Dₘ_{_{acc}}^{N} and the reduced sampling the region of the boundary of m_{acc} that intersects the non-compliant domains of the other two metrics.

In a third example, compliance boundary detection as a development tool is described. Referring again to FIG. 12, an unprotected turn scenario 1220 is illustrated. An AV 1224 navigates along a path 1224A on the carriageway 1222A, and an agent 1226 navigates along a 1226A on the carriageway 1222B. The AV 1224 turns across the intersection 1222C, and the path 1224A of the AV 1224 crosses the path 1226A of the agent 1226.

In examples, behavior of a planning system of the AV 1224 for an unprotected turn in a four-way intersection is evaluated. The scenario in question is set at in left-hand traffic where the AV 1224 takes an unprotected right turn. As the AV 1224 enters the intersection, the AV 1224 detects an oncoming vehicle (agent) 1226 that it needs to yield to, or to clear the intersection before the agent enters it. The distance of the agent 1226 to the intersection (p₁∈[0 m, 60 m]) is parameterized, as well as the agent's constant speed (p₂∈[5 m/s, 12 m/s]). If the agent 1226 vehicle is far away or is moving slowly, the AV 1224 can clear the intersection before it. Similarly, if the agent 1226 vehicle appears very close or is very fast, it will clear the intersection before the AV 1224 intersects its path. In all other cases, the AV 1224 would have to stop and yield.

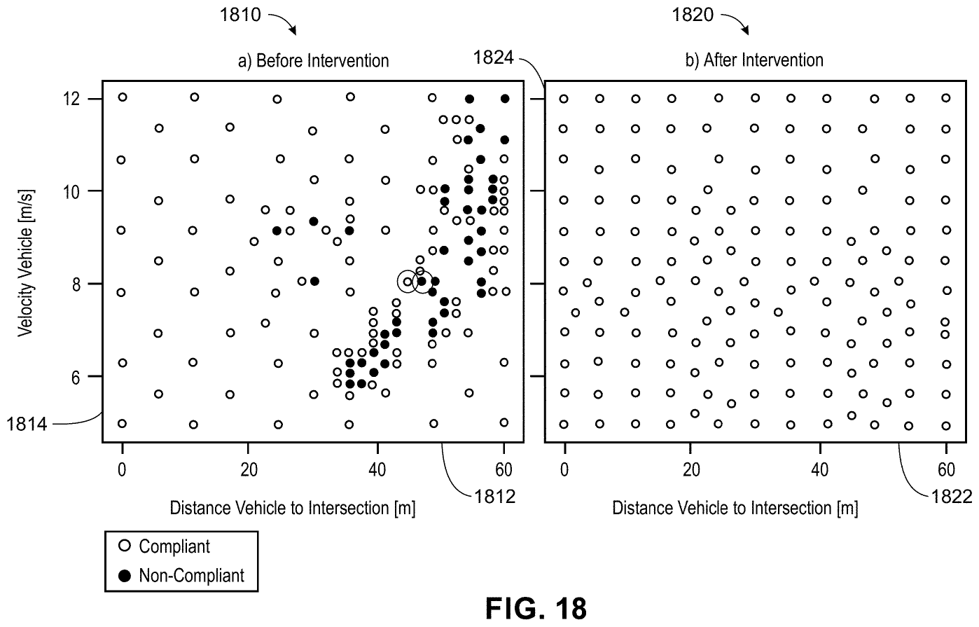

FIG. 18 shows points on the no traffic conflict compliance boundary for the unprotected turn scenario before (1810) and after (1820) investigating and rectifying the unsafe phenomenon. In the plots shown, the x-axis (1812, 1822) represents the distance of the vehicle to the intersection, and the y-axis (1814, 1824) represents the vehicle velocity. As illustrated in FIG. 18, an exploration of the traffic conflict metric m_{col} with GPC-P-SF (Matern, 0.2, 150 iterations) is executed, resulting in the points on the boundary estimate plotted in FIG. 18. In examples, the result shows that the current state of the AV system (e.g., planning system 404 of FIG. 4A) handled vehicles appearing very close and moving with high velocities but fails for much simpler cases. To understand this behavior, a closer inspection of scenario pairs lying on different sides of the border is performed.

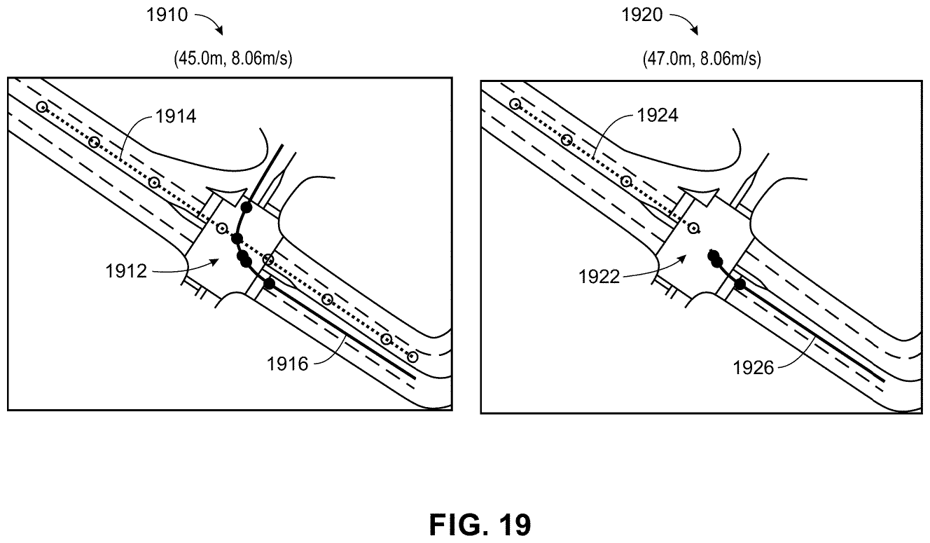

FIG. 19 shows a plot of the tracks of the AV (1916, 1926) and agent (1914, 1924) for the two marked cases in FIG. 18. Markers with the same shape (solid black circle or open circle) designate locations at which the two vehicles (e.g., 1224 and 1226 of FIG. 12) were at the same time. For example, the tracks of the marked pair of concrete scenarios are shown in FIG. 19. In the compliant case 1920, the AV 1224 stops at the appropriate stop line in the intersection (1912, 1922) and yields to the agent 1226 vehicle, as shown by the AV track 1926. In the non-compliant case 1910, with the agent 1226 vehicle starting just two meters further away, the behavior is drastically different: the AV 1224 slows down but does not stop, which results in a traffic conflict with the agent 1226 vehicle (e.g., a traffic conflict between tracks 1914 and 1916). A close inspection of the two marked scenarios determined the cause of this behavior to be an inappropriate choice of some of the parameters governing the intersection navigation behavior. The maximum time until the agent enters the intersection for which the ego yields was set too low. Increasing this parameter from 4 to 10 seconds, and running framework once again to verify the effect of the changes demonstrated a much improved compliant domain as shown in FIG. 18.

The area of the non-compliant region in FIG. 18 is very small relative to the total area. If only a single or a handful of pre-determined concrete scenarios were employed, likely none of them would have been in the non-compliant region, incorrectly indicating safe behavior for this logical scenario. On the other hand, a parameter sweep over the same 33×33 grid, would require more than 7 times the number of scenario evaluations, almost all of which would be very easy to handle and far from the compliance boundary. Hence, the framework according to the present techniques enables successful detection of the non-compliant region without performing unnecessary sampling.

The examples described herein demonstrate that the framework can explore the compliance boundary for rules with binary and continuous violation metrics, as well as complex combinations of them, while significantly reducing the number of simulations needed relative to a parameter sweep. While the examples were restricted to two dimensions, the present techniques are applicable to higher dimensions as well. The insight provided by the framework described herein can be indispensable for the development process. For instance, pairs of scenarios exemplifying current issues present invaluable context for performing root cause analysis and rectification. The framework can also be leveraged as a systems engineering tool to monitor the development progress towards satisfaction of complex requirements, namely, by tracking the evolution of Dₘ_{ₜₒₜ}^{C} or Dₘ^{C}. Through tracking the evolution of whole domain D rather than one or few single points in it, the framework provides an advantage to the traditional library testing strategy.

While the framework has been described with an AV as an autonomous system, the technique is applicable to any autonomous system that can be tested in simulation. The use-case is not limited to safety evaluation and can be applied also to any experimental setups (e.g. materials design, in vitro studies) where any combination of parameters can be physically tested in a safe manner. Even though the examples considered here were restricted to two dimensions, the same techniques can be employed in higher dimensions as well. The single metric algorithms can also be replaced with other active learning algorithms, as the framework is agnostic of the specific algorithm choice.

In some embodiments, a hyperparameter-tuning procedure is implemented for the algorithms described herein. The present techniques can be employed in a continuous integration pipeline by automatically determining if a new feature constitutes improvement, regression, or neither. In some embodiments, batch sampling algorithms enable fast identification of compliant/non-compliant domain volumes via parallel simulation execution. Additionally, statistical guarantees on the performance of the boundary detection algorithms can strengthen the confidence in the identification of compliant/non-compliant domain volumes according to the present techniques.

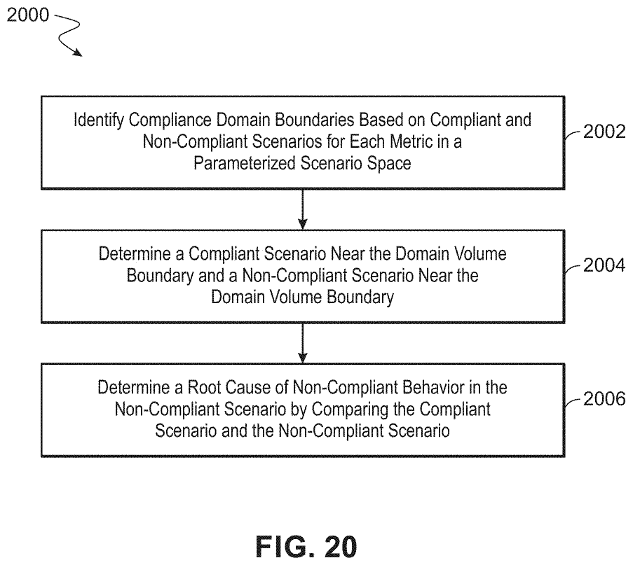

FIG. 20 is a process flow diagram of a method 2000 for search algorithms and safety verification using compliant domain volumes. In some embodiments, process 2000 is implemented (e.g., completely, partially, etc.) using a planning system that is the same as or similar to planning system 404, described in reference to FIG. 4A. In some embodiments, one or more of the steps of process 2000 are performed (e.g., completely, partially, and/or the like) by another device or system, or another group of devices and/or systems that are separate from, or include, the planning system. For example, one or more steps of process 2000 can be performed (e.g., completely, partially, and/or the like) by remote autonomous vehicle (AV) system 114, fleet management system 116, and V2I system 118 of FIG. 1, autonomous system 202 of FIG. 2, device 300 of FIG. 3, AV compute 400A of FIG. 4A (e.g., one or more systems of AV compute 400A), active learning system 400B of FIG. 4B, implementation 500 of FIG. 5, and/or system 700 of FIG. 7. In some embodiments, the steps of process 2000 may be performed between any of the above-noted systems in cooperation with one another.

At block 2002, a parameterized scenario space and objective function are identified. In some embodiments, the objective function corresponds to at least one metric or a combination of metrics. In examples, the parameterized scenario space is selected to cover an ODD. For example, the parameterized scenario space includes logical scenarios with at least one parameter that substantially corresponds to test cases of the ODD. Objective functions are used to evaluate behavior of an autonomous system in response to the scenarios of the parameterized scenario space. For example, metrics are defined that evaluate the response of an autonomous system in a concrete scenario.

At block 2004, a boundary is identified between compliant scenarios and non-compliant scenarios in the parameterized scenario space for each respective metric of the at least one metric or the combination of metrics. In some embodiments, active learning (e.g., active learning system 400B of FIG. 4B) is used to identify the boundary between safe and unsafe behavior of the AV based on the metrics. The active learning algorithms applied to the concrete scenarios vary according to each metric, and are based on a data type of each respective metric. In examples, a data type is a single rule with a continuous metric, a single rule with a binary metric, collection of rules, combination of rules, hierarchy of rules, or any combinations thereof. Thus, the active learning system can execute a single rule with a continuous metric exploration procedure, collection of rules exploration procedure, combination of rules exploration procedure, hierarchy of rules exploration procedure, or any combinations thereof.

At block 2006, a total volume boundary of a domain volume corresponding to the parameterized scenario space is identified based on the compliant and non-compliant scenarios. In embodiments, surfaces (e.g., surfaces 910, 920 of FIG. 9) corresponding to each respective metric are combined to form a domain volume (e.g., domain volume 930 of FIG. 9). The total boundary separates concrete scenarios that are identified as compliant scenarios on surfaces of the volume from the concrete scenarios that are not as compliant across surfaces of the volume.

In some embodiments, the total boundary is used to identify concrete scenarios that correspond to test cases of an ODD. Simulations of the concrete scenarios neighboring or adjacent to the total boundary enables safety verification of an autonomous system within a corresponding ODD. In some examples, a scenario neighbors the total boundary when, for example, the scenario is located within a predetermined area of the surface that includes the total boundary. For example, an AV's compliant domain is searched using the active learning approach described above. If the AV is compliant in the parameterized scenario spaces identified according to the present techniques, then the entire ODD is covered by the current simulations as a required compliant domain volume is tested and the AV behaves as expected. In embodiments, an exploration process iteratively refines the boundary between scenarios that are labeled as safe or unsafe. If two scenarios that are very close or very similar are selected, where one scenario is labeled as safe and the other scenario is labeled as unsafe, the differences between the scenarios create a starting point for root cause analysis to determine the AV behavior that causes the unsafe scenario. For example, in a first parametrized scenario an agent might be at a first, original location, and in a second parameterized scenario the agent has moved less than a meter from the original location. If the small changes result in a crash, this can inform a safety verification tool that a condition of the AV that has changed that results in a collision or other unsafe situation. By analyzing similar scenarios and determining exactly what happens at the AV in response to the similar scenarios, an exact reason for the AV behavior can be determined. The search algorithms and safety verification as described herein enables the evaluation of autonomous systems such that those which are exceptionally safe identified relative to other safe systems. Potential safety issues are identified as soon as possible, with as few resources (e.g., computing, miles driven, etc.) for as possible while keeping costs associated with discovering the issues are low (e.g., using fewer compute resources to identify issues indicates a lower cost of determining the issues).

According to some non-limiting embodiments or examples, provided is a method, comprising: identifying, with at least one processor, a parameterized scenario space and objective function, the objective function comprising at least one metric or a combination of metrics; determining, with the at least one processor, boundaries between compliant scenarios and non-compliant scenarios in the parameterized scenario space for respective metrics of the at least one metric or a combination of metrics; and identifying, with the at least one processor, a total boundary of a domain volume corresponding to the parameterized scenario space based on the boundaries between the compliant scenarios and the non-compliant scenarios.

According to some non-limiting embodiments or examples, provided is a system, comprising: at least one processor, and at least one non-transitory storage media storing instructions that, when executed by the at least one processor, cause the at least one processor to: identify a parameterized scenario space and objective function, the objective function comprising at least one metric or a combination of metrics; determine boundaries between compliant scenarios and non-compliant scenarios in the parameterized scenario space for respective metrics of the at least one metric or a combination of metrics; and identify a total boundary of a domain volume corresponding to the parameterized scenario space based on the boundaries between the compliant scenarios and the non-compliant scenarios.

According to some non-limiting embodiments or examples, provided is at least one non-transitory computer-readable medium comprising one or more instructions that, when executed by at least one processor, cause the at least one processor to: identify a parameterized scenario space and objective function, the objective function comprising at least one metric or a combination of metrics; determine boundaries between compliant scenarios and non-compliant scenarios in the parameterized scenario space for respective metrics of the at least one metric or a combination of metrics; and identify a total boundary of a domain volume corresponding to the parameterized scenario space based on the boundaries between the compliant scenarios and the non-compliant scenarios.

Further non-limiting aspects or embodiments are set forth in the following numbered clauses:

Clause 1: A method, comprising identifying, with at least one processor, a parameterized scenario space and objective function, the objective function comprising at least one metric or a combination of metrics; determining, with the at least one processor, boundaries between compliant scenarios and non-compliant scenarios in the parameterized scenario space for respective metrics of the at least one metric or a combination of metrics; and identifying, with the at least one processor, a total boundary of a domain volume corresponding to the parameterized scenario space based on the boundaries between the compliant scenarios and the non-compliant scenarios.

Clause 2: The method of clause 1, wherein the boundaries between the compliant scenarios and the non-compliant scenarios are determined for respective metrics based on an exploration procedure, the exploration procedure corresponding to a data type associated with the respective metrics.

Clause 3: The method of any of clauses 1 or 2, wherein an exploration algorithm identifies a respective scenario as compliant or non-compliant based on a sub-type of a respective metric.

Clause 4: The method of any of clauses 1-3, wherein the domain volume comprises surfaces that correspond to the respective metrics.

Clause 5: The method of any of clauses 1-4, further comprising: executing simulations at an autonomous system corresponding to compliant scenarios and non-compliant scenarios that neighbor the total boundary, and verifying safety of the autonomous system based on the simulations.

Clause 6: The method of any of clauses 1-5, comprising updating a surface of the domain volume and selecting a scenario to simulate based on the updated surface.

Clause 7: The method of any of clauses 1-6, wherein an active learner is iteratively updated based on an output of other active learners applied to a same domain volume.

Clause 8: A system, comprising: at least one processor, and at least one non-transitory storage media storing instructions that, when executed by the at least one processor, cause the at least one processor to: identify a parameterized scenario space and objective function, the objective function comprising at least one metric or a combination of metrics; determine boundaries between compliant scenarios and non-compliant scenarios in the parameterized scenario space for respective metrics of the at least one metric or a combination of metrics; and identify a total boundary of a domain volume corresponding to the parameterized scenario space based on the boundaries between the compliant scenarios and the non-compliant scenarios.

Clause 9: The system of clause 8, wherein the boundaries between the compliant scenarios and the non-compliant scenarios are determined for respective metrics based on an exploration procedure, the exploration procedure corresponding to a data type associated with the respective metrics.

Clause 10: The system of any of clauses 8 or 9, wherein an exploration algorithm identifies a respective scenario as compliant or non-compliant based on a sub-type of a respective metric.

Clause 11: The system of any of clauses 8-10, wherein the domain volume comprises surfaces that correspond to the respective metrics.

Clause 12: The system of any of clauses 8-11, further comprising: executing simulations at an autonomous system corresponding to compliant scenarios and non-compliant scenarios that neighbor the total boundary, and verifying safety of the autonomous system based on the simulations.

Clause 13: The system of any of clauses 8-12, comprising updating a surface of the domain volume and selecting a scenario to simulate based on the updated surface.

Clause 14: The system of any of clauses 8-13, wherein an active learner is iteratively updated based on an output of other active learners applied to a same domain volume.

Clause 15: At least one non-transitory storage media storing instructions that, when executed by at least one processor, cause the at least one processor to: identify a parameterized scenario space and objective function, the objective function comprising at least one metric or a combination of metrics; determine boundaries between compliant scenarios and non-compliant scenarios in the parameterized scenario space for respective metrics of the at least one metric or a combination of metrics; and identify a total boundary of a domain volume corresponding to the parameterized scenario space based on the boundaries between the compliant scenarios and the non-compliant scenarios.

Clause 16: The at least one non-transitory storage media of clause 15, wherein the boundaries between the compliant scenarios and the non-compliant scenarios are determined for respective metrics based on an exploration procedure, the exploration procedure corresponding to a data type associated with the respective metrics.

Clause 17: The at least one non-transitory storage media of clauses 15 or 16, wherein an exploration algorithm identifies a respective scenario as compliant or non-compliant based on a sub-type of a respective metric.

Clause 18: The at least one non-transitory storage media of any of clauses 15-17, wherein the domain volume comprises surfaces that correspond to the respective metrics.

Clause 19: The at least one non-transitory storage media of any of clauses 15-18, further comprising: executing simulations at an autonomous system corresponding to compliant scenarios and non-compliant scenarios that neighbor the total boundary, and verifying safety of the autonomous system based on the simulations.

Clause 20: The at least one non-transitory storage media of any of clauses 15-19, comprising updating a surface of the domain volume and selecting a scenario to simulate based on the updated surface.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, the term “further comprising” is used in the foregoing description or following claims, what follows this phrase can be an additional step or entity, or a sub-step/sub-entity of a previously-recited step or entity.

1. A method, comprising
identifying, with at least one processor, a parameterized scenario space and objective function, the objective function comprising at least one metric or a combination of metrics;
determining, with the at least one processor, boundaries between compliant scenarios and non-compliant scenarios in the parameterized scenario space for respective metrics of the at least one metric or a combination of metrics; and
identifying, with the at least one processor, a total boundary of a domain volume corresponding to the parameterized scenario space based on the boundaries between the compliant scenarios and the non-compliant scenarios.

2. The method of claim 1, wherein the boundaries between the compliant scenarios and the non-compliant scenarios are determined for respective metrics based on an exploration procedure, the exploration procedure corresponding to a data type associated with the respective metrics.

3. The method of claim 1, wherein an exploration algorithm identifies a respective scenario as compliant or non-compliant based on a sub-type of a respective metric.

4. The method of claim 1, wherein the domain volume comprises surfaces that correspond to the respective metrics.

5. The method of claim 1, further comprising:
executing simulations at an autonomous system corresponding to compliant scenarios and non-compliant scenarios that neighbor the total boundary, and
verifying safety of the autonomous system based on the simulations.

6. The method of claim 1, comprising updating a surface of the domain volume and selecting a scenario to simulate based on the updated surface.

7. The method of claim 1, wherein an active learner is iteratively updated based on an output of other active learners applied to a same domain volume.

8. A system, comprising:
at least one processor, and
at least one non-transitory storage media storing instructions that, when executed by the at least one processor, cause the at least one processor to:
identify a parameterized scenario space and objective function, the objective function comprising at least one metric or a combination of metrics;
determine boundaries between compliant scenarios and non-compliant scenarios in the parameterized scenario space for respective metrics of the at least one metric or a combination of metrics; and
identify a total boundary of a domain volume corresponding to the parameterized scenario space based on the boundaries between the compliant scenarios and the non-compliant scenarios.

9. The system of claim 8, wherein the boundaries between the compliant scenarios and the non-compliant scenarios are determined for respective metrics based on an exploration procedure, the exploration procedure corresponding to a data type associated with the respective metrics.

10. The system of claim 8, wherein an exploration algorithm identifies a respective scenario as compliant or non-compliant based on a sub-type of a respective metric.

11. The system of claim 8, wherein the domain volume comprises surfaces that correspond to the respective metrics.

12. The system of claim 8, further comprising:
executing simulations at an autonomous system corresponding to compliant scenarios and non-compliant scenarios that neighbor the total boundary, and
verifying safety of the autonomous system based on the simulations.

13. The system of claim 8, comprising updating a surface of the domain volume and selecting a scenario to simulate based on the updated surface.

14. The system of claim 8, wherein an active learner is iteratively updated based on an output of other active learners applied to a same domain volume.

15. At least one non-transitory storage media storing instructions that, when executed by at least one processor, cause the at least one processor to:
identify a parameterized scenario space and objective function, the objective function comprising at least one metric or a combination of metrics;
determine boundaries between compliant scenarios and non-compliant scenarios in the parameterized scenario space for respective metrics of the at least one metric or a combination of metrics; and
identify a total boundary of a domain volume corresponding to the parameterized scenario space based on the boundaries between the compliant scenarios and the non-compliant scenarios.

16. The at least one non-transitory storage media of claim 15, wherein the boundaries between the compliant scenarios and the non-compliant scenarios are determined for respective metrics based on an exploration procedure, the exploration procedure corresponding to a data type associated with the respective metrics.

17. The at least one non-transitory storage media of claim 15, wherein an exploration algorithm identifies a respective scenario as compliant or non-compliant based on a sub-type of a respective metric.

18. The at least one non-transitory storage media of claim 15, wherein the domain volume comprises surfaces that correspond to the respective metrics.

19. The at least one non-transitory storage media of claim 15, further comprising: executing simulations at an autonomous system corresponding to compliant scenarios and non-compliant scenarios that neighbor the total boundary, and
verifying safety of the autonomous system based on the simulations.

20. The at least one non-transitory storage media of claim 15, comprising updating a surface of the domain volume and selecting a scenario to simulate based on the updated surface.
